(19) United States
(12) Patent Application Publication
(10) Pub. No.: US 2016/0027113 A1
(43) Pub. Date: Jan. 28, 2016

(54) SYSTEM AND METHOD FOR DEVELOPING TRADING STRATEGIES THROUGH A GRAPHICAL USER INTERFACE

(71) Applicant: RA CAPITAL CORPORATION LIMITED, London (GB)

(72) Inventor: Ranjit Sodhi, Stevenage (GB)

(73) Assignee: RA CAPITAL CORPORATION LIMITED

(21) Appl. No.: 14/809,025

(22) Filed: Jul. 24, 2015

Related U.S. Application Data
(60) Provisional application No. 62/028,739, filed on Jul. 24, 2014.

(51) Int. Cl. G06Q 40/04; G06F 3/0484; G06F 3/0482

(52) U.S. Cl. CPC G06Q 40/04; G06F 3/0482; G06F 3/04847

(57) ABSTRACT

A system and method for providing a framework for developing trading strategies through a graphical user interface includes a client device functionally associated with a network which displays the graphical user interface; an interfacing server, functionally associated with the client device through the network; a transaction server which facilitates transfer of data/information/metadata associated with the user; a database/data store, functionally associated with the transaction server which stores data including the user data; a portfolio management and trading module functionally associated with the database/data store which facilitates position selection, trade of financial instruments and all associated portfolio and trade management functions and a financial instrument related data analyzer functionally associated with the interfacing server wherein said graphical user interface uses symbols and context to enable the user to build, test, review and implement a trading strategy for trade of financial instruments.

### CROSS-REFERENCE TO RELATED APPLICATIONS

This application claims priority to U.S. Provisional Patent Application No. 62/028,739, which was filed Jul. 24, 2014. The disclosure of the Provisional Patent application is herein incorporated by reference in its entirety and for all purposes.

### FIELD

The present disclosure relates to providing a graphical user interface and platform for developing trading strategies. More specifically, the present disclosure relates to providing a platform for building, testing, reviewing, calibrating and implementing trading strategies through a graphical user interface.

### BACKGROUND

One of the first steps to becoming a successful trader is to develop a successful trading strategy. This is true for any kind of trading, such as the trading of Financial Instruments (F.I.) (e.g., stocks, bonds, foreign currencies, and so on).

A trading strategy can be defined as a set of objective rules designating the conditions that must be met for trade entries and exits to occur. A trading strategy includes specifications for trade entries, including trade filters, and triggers, as well as rules for trade exits, money management, timeframes, order types, etc.

An overall trading strategy can and should include a variety of subordinate trading strategies for different parts of an investor's portfolio. For example, one might decide that the stock portion of his/her portfolio should have a mix of certain percentage of long-term growth and income and rest in highly speculative stocks. An investor would likely have a somewhat different trading strategy for each class.

An important part of creating a trading strategy is to examine an investor's own goals, needs, personality, and interests. For example, an investor may look for investing for a specific purpose in a relatively short period of time or for a retirement that's forty years away. An investor may have a varying risk appetite. These types of factors will influence an investor's choice of investments and the trading strategy he/she chooses.

Overall, parts of every trading strategy should include decisions based, for example, on markets (e.g., stocks, options, Forex, taxation etc.), time frame, type of assets within a market, amounts of money to be committed, and whether this money will be committed lump sum or committed over a period of time. Then there is a need to drill down and set rules for when to buy and sell, and how much capital to commit to each trade. Once a trading strategy is developed, it should be tested, reviewed, and calibrated before implementation.

Traditional computer based frameworks allow an investor to build, test, review, calibrate, and implement a trading strategy. However, the user interfaces offered by the existing computer based frameworks are very complex and, to perform the trading strategy activities in such an environment, an investor must possess high level of knowledge and skill.

For example, U.S. Pat. No. 6,493,681 discloses a system and method for generation of strategies of investment in publicly traded stocks and a method of choosing the strategy with capital gain greater than traditional buy and hold strategy. This conventional approach is capable of generating thousands of investment strategies finding the best strategy that delivers the optimal capital gain. The user interface of this system enables the investor to analyze the dynamics and stability of their chosen strategy over time.

U.S. Patent Publication No. 2007/0130043 discloses a system and method to provide automated investment allocation advice, selection of investment securities, customization of the automated advice, execution of investment securities, and maintenance of investment portfolios and rebalancing of investment portfolios. A user is connected to the Internet and connects to a portfolio management program (PMP) host computer. The user completes a questionnaire that the PMP uses to generate a suitable investment allocation and specific portfolio strategy recommendation. The user reviews the strategy and specific information about the strategy. The information includes historic and/or hypothetical performance, historical and/or hypothetical holdings, current securities selections of the strategy, and a description of the strategy's selection methodology. The user, after making appropriate reviews, makes a decision to purchase the instruments in that portfolio. Both of U.S. Pat. No. 6,493,681 and U.S. Patent Publication No. 2007/0130043 are herein incorporated by reference in their entirety and for all purposes.

The prior art systems and methods discussed above focus only on specific aspects of trading strategies and do not offer the user the facility to build, test, review, and implement a complete trading strategy through an easy to operate graphical user interface. Further, these systems do not offer the user the ability to program both price and non-price data. These systems are designed to meet a specific user case and are not easily adapted for other trading scenarios (e.g., dividend trading).

In view of the foregoing, a need exists for an improved system with user friendly interface for performing the tasks associated with trading strategy in an effort to overcome the aforementioned obstacles and deficiencies of conventional systems.

### BRIEF DESCRIPTION OF THE DRAWINGS

FIG. 1 is an exemplary embodiment of a system diagram for developing trading strategies through a graphical user interface (GUI);

FIG. 2 is one embodiment of a flow chart of a process for developing, testing, reviewing, calibrating, and implementing a trading strategy that can be used with the system of FIG. 1;

FIG. 3 illustrates an exemplary embodiment of a screen shot of the GUI select mode of FIG. 2;

FIG. 4 illustrates one embodiment of an exemplary screen shot of the GUI in select trader profile mode that can be used with the mode selected in FIG. 3;

FIG. 5 illustrates one embodiment a trader type table that can be used with the trader profiles of FIG. 4;

FIG. 6 illustrates an embodiment of an exemplary screen shot of a GUI for creating a portfolio;

FIG. 7A illustrates an embodiment of an instrument portfolio correlation test summary table that can be used with the portfolio(s) selected in FIG. 6;

FIG. 7B illustrates another embodiment of the instrument portfolio correlation test results summary table that can be used with the portfolio(s) selected in FIG. 6;

FIG. 8 illustrates an embodiment of an exemplary screen shot of a GUI for managing portfolios that can be used with the portfolio(s) selected in FIG. 6;

FIG. 9 illustrates an embodiment of a capital allocation table that can be used with the portfolio(s) selected in FIG. 6;

FIG. 10A illustrates an embodiment of a position/trade size adjustment calculation table;

FIG. 10B illustrates an embodiment of a portfolio limits settings table;

FIG. 11A illustrates an embodiment of a settings table for structured/derivatives instrument trading that can be used with the structure positions adjustment slider selection in FIG. 8;

FIG. 11B illustrates an embodiment of a setting table for managing roll over in futures trading;

FIG. 12 illustrates an embodiment of a GUI for managing portfolio(s);

FIG. 13 illustrates an embodiment of the GUI for selecting preferred trading style mode;

FIG. 14 illustrates an embodiment of a GUI for generating trading signals that can be used with the trading methodology selection in FIG. 13;

FIG. 15 illustrates an embodiment of a GUI for selecting and calibrating signal filter(s);

FIG. 16 illustrates an embodiment of a GUI for preferred method of trading with broker;

FIG. 17 illustrates an embodiment of a GUI for how many trades to execute per position;

FIG. 18 illustrates an embodiment of a GUI for defining the size of each trade within a position that can be used with the number of trades to execute adjustment slider selection in FIG. 17;

FIG. 19 illustrates an embodiment of a GUI for defining the rate at which to add each trade that can be used with the number of trades to execute adjustment slider selection in FIG. 17;

FIG. 20 illustrates an embodiment of a GUI for positioning stop losses for each trade that can be used with the number of trades to execute adjustment slider selection in FIG. 17;

FIG. 21 illustrates an embodiment of a GUI for defining the preferred method of exiting positions;

FIG. 22A illustrates an embodiment of a position manager table that can be used with the GUIs of FIGS. 17-20;

FIG. 22B illustrates an embodiment of another position manager table that can be used with GUIs of FIGS. 17-20;

FIG. 23A illustrates an embodiment of an exit manager table in first strike mode that can be used with the exit methodology adjustment slider selection in FIG. 21;

FIG. 23B illustrates an embodiment of an exit manager table in second strike mode that can be used with the exit methodology adjustment slider selection in FIG. 21;

FIG. 24 illustrates an embodiment of exit manager table in third strike mode that can be used with the exit methodology adjustment slider selection in FIG. 21;

FIG. 25 illustrates an embodiment of a GUI in review trading results initiation mode;

FIG. 26 illustrates an embodiment of a GUI in review mode that can be used to review the process of FIG. 2;

FIG. 27 illustrates an embodiment of a GUI in live mode that can be used with the mode selected in FIG. 26;

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

It is an object of the present disclosure to provide a system for developing trading strategies through a graphical user interface.

Another object of the present disclosure is to provide a system which enables the use of commonly used symbols in graphical user interfaces to be combined with any other symbol and the use of context and hence, allows for the easy combination of symbol(s) and context to enable user(s) to build any trading strategy for trade of financial instruments (F.I.).

Yet another object of the present disclosure is to provide a framework which enables the use of commonly used symbols in graphical user interface to be combined with any other symbol and the use of context and hence, allows for the easy combination of symbol(s) and context to enable user(s) to test any trading strategy built in the system by the user.

Another object of the present disclosure is to provide a framework which enables use of commonly used symbols in graphical user interface to be combined with any other symbol and the use of context and hence, allows for the easy combination of symbol(s) and context to enable user(s) to review and calibrate any trading strategy built in the system by the user.

A further object of the present disclosure is to provide a framework which enables use of commonly used symbols in graphical user interface to be combined with any other symbol and the use of context and hence, allows for the easy combination of symbol(s) and context to enable user(s) to implement any trading strategy built on the system by the user.

Another object of the present disclosure is to provide a much simpler and familiar interface that requires minimal technical skills of the end user in achieving programmatic tasks than existing approaches.

The present disclosure is a system and method for development, testing, review, calibration and live implementation of a trading strategy. According to an exemplary embodiment of the present disclosure, there may be provided a server or server cluster including at least one Interfacing Server adapted to interface with a user, via a distributed data network such as the internet. The Interfacing Server may be adapted to present to the user a graphical user interface for development, testing, review, calibration and live implementation of a trading strategy and to receive from the user instructions and execute them. The server or server cluster may further comprise a transaction server, a database/data store, a trading module, a portfolio management module, an F.I. related data analyzer and a gateway. The servers within the cluster may each be functionally associated with a communication module which in turn may be functionally associated with the gateway and adapted to communicate with one or more of the other components of the system and to relay through the gateway communications from/to the one or more servers over a distributed data network, such as the Internet. Any and all computational architecture known today or to be devised in the future may be applicable to the present disclosure.

In a preferred embodiment of the present disclosure, the system includes presentation of a graphic user interface (GUI) which makes use of symbols on the display unit of client device for the user to develop (build), test, review, calibrate, and implement a trading strategy. The GUI framework of the present disclosure takes advantage of existing social conditioning of humans and the familiar symbol(s) they interact with in everyday life and hence, are familiar with/already conditioned to understand and know how to interact with. The GUI framework of the present disclosure enables any symbol(s) to be combined with any other symbol(s) to enable the user to meet any objective(s) such as defining, testing, analysing and calibrating any trading strategy and within a much simpler and familiar interface that requires much lower/minimal technical skills of the end user. Further, the GUI framework also allows for the interaction with other user types such as computers, robots and any other forms of artificial intelligence.

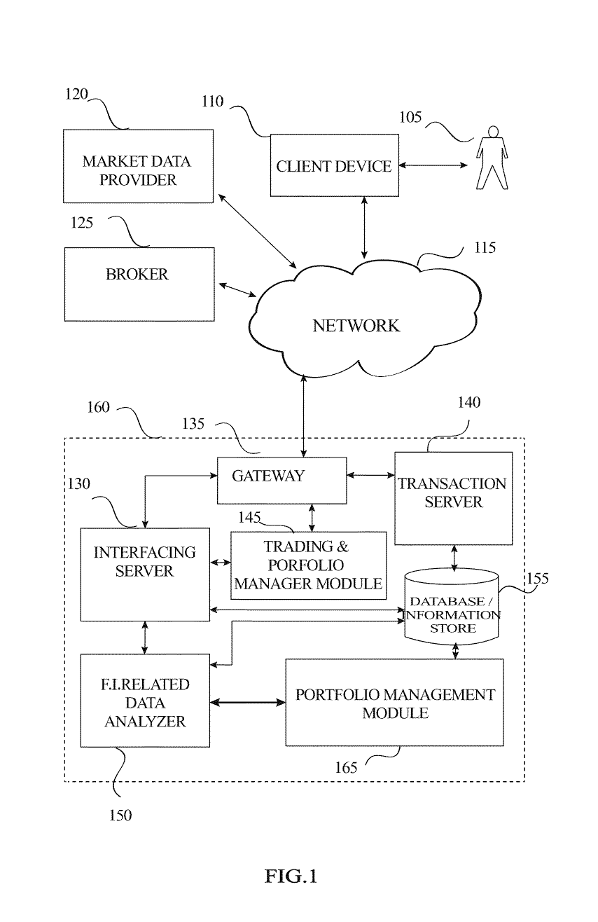

Since currently-available computer-based trading systems are deficient because they do not offer the user the facility to build, test, review, calibrate and implement a complete trading strategy through an easy to operate graphical user interface, a trading platform that provides an improved system with user friendly interface for performing the tasks associated with trading strategy can prove desirable and provide a basis for a wide range of trading applications, such as, providing a framework for a graphical user interface which uses everyday symbols and context for easy interaction with the user for building, testing, reviewing and implementing trading strategy. This result can be achieved, according to one embodiment disclosed herein, by a system as illustrated in FIG. 1.

The system of FIG. 1 can provide a framework for development (building), testing, review, calibration and live implementation of a trading strategy. According to an exemplary embodiment, the system of FIG. 1 includes a server 160. The server 160 can represent a single server or a server cluster. As shown in FIG. 1, the server 160 includes at least one Interfacing Server 130 adapted to interface with a user 105 (such as an end user) via a distributed data network 115, such as the Internet. The Interfacing Server 130 may be adapted to present to the user 105 a graphical user interface (GUI) for development, testing, review, calibration, and implementing a trading strategy and to receive, from the user 105, instructions and execute them. The server 160 may further comprise a transaction server 140, a database 155, a trading and portfolio manager module 145, a F.I. related data analyzer 150, a portfolio management module 165, and a gateway 135. Each of the subcomponents of the server 160, for example, as described above, may be functionally associated with a communication module (not shown) that may be functionally associated with the gateway 135 and adapted to communicate with one or more of the brokers 125, the market data providers 120, and a client device 110 to bi-directionally relay data through the gateway 135 over the distributed data network 115.

In some embodiments, the server 160 may reside in one or a set of physical servers and/or across sets of redundant physical or virtual servers.

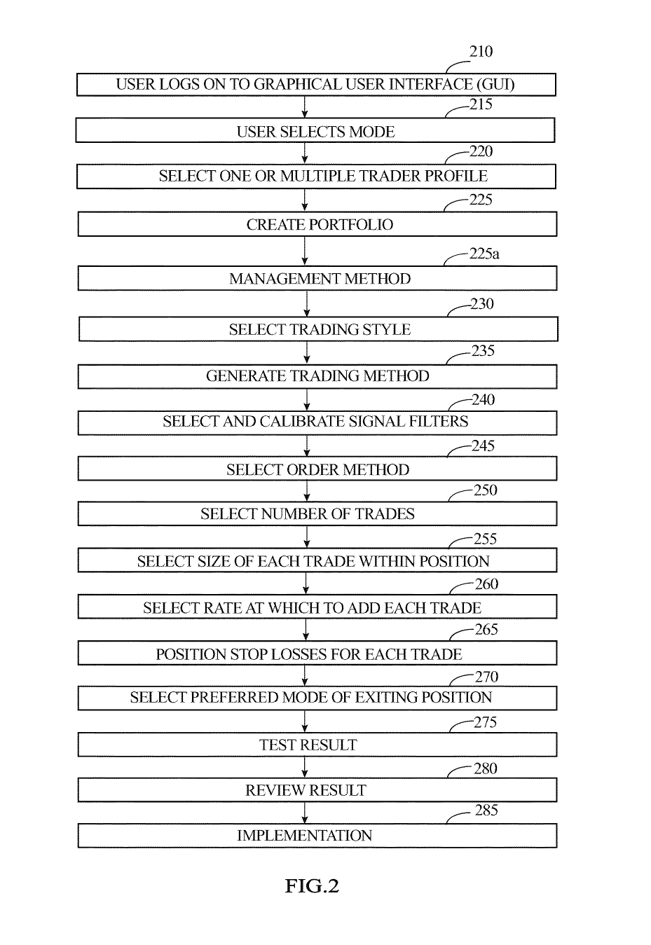

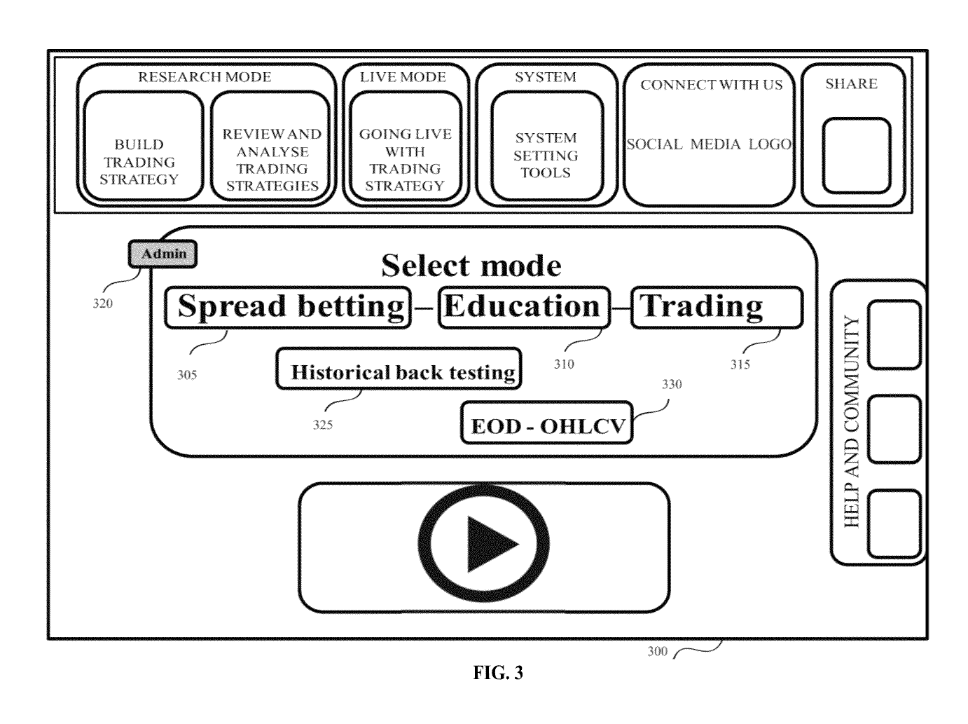

According to some embodiments, the Interfacing Server 130 presents to the user 105, for example, on the client device 110 (such as, but not limited to, a personal computer (PC), a cellular phone, a body worn/wearable, a tablet, an Interactive television) a GUI (such as GUI 300 shown in FIG. 3) for development, testing, review, calibration, and implementing a trading strategy, as described below. The process for the trading platform (such as a process shown in FIG. 2) may be embodied on a computer-readable medium stored on the database 155 and functionally associated with the Interfacing Server 130. One or more of the functions described as being performed by a server (e.g., the Interfacing Server 130) may be performed alternatively by an application instanced on the client device 110, which application may be pre-installed on the client device 110 or downloaded to the client device 110 by the Interfacing Server 130 as needed.

In a preferred embodiment as illustrated in FIG. 3, a GUI such as a GUI 300 makes use of symbols like a spread betting input 305, an education input 310, and a trading input 315, for example, on the display unit of the client device 110. The GUI 300 allows the user 105 to develop, test, review, calibrate, and implement a trading strategy. The GUI 300 takes advantage of social conditioning of humans and symbol(s) users interact with in everyday life and hence, are familiar with/already conditioned to understand and know how to interact with these symbols. The GUI 300 enables any symbol(s) to be combined with any other symbol(s) to enable the user 105 to meet any objective(s) such as defining, testing, analysing, calibrating, and implementing any trading strategy and within a much simpler and familiar interface that requires much lower/minimal technical skills of the user 105. Further, the GUI 300 also allows for the interaction with other user types such as binary instruction sets for computers; machine readable formats for robots (barcodes, etc.) and any other forms of artificial intelligence.

The symbols used in the GUI 300 may come from any source including symbol collections such as: Abstract symbols; Agriculture/Gardening; Animals/Wildlife; The Arts; Astrology; Backgrounds/Textures; Beauty/Fashion/Clothing; Buildings/Landmarks; Business/Finance; Celebrities/Media; Editorial; Education; Food and Drink; Geographic; Healthcare/Medical; History; Holidays; Illustrations/Clip-Art/Cartoons; Industrial; Interiors; Nature; Everyday objects; House and home; Parks/Outdoor; People; Religion; Science; Signs/Symbols; Sports/Recreation; Technology; Transportation; Mathematics; Machine readable formats (barcodes; binary); Alphabets; Numbering systems; Hieroglyphics; etc.

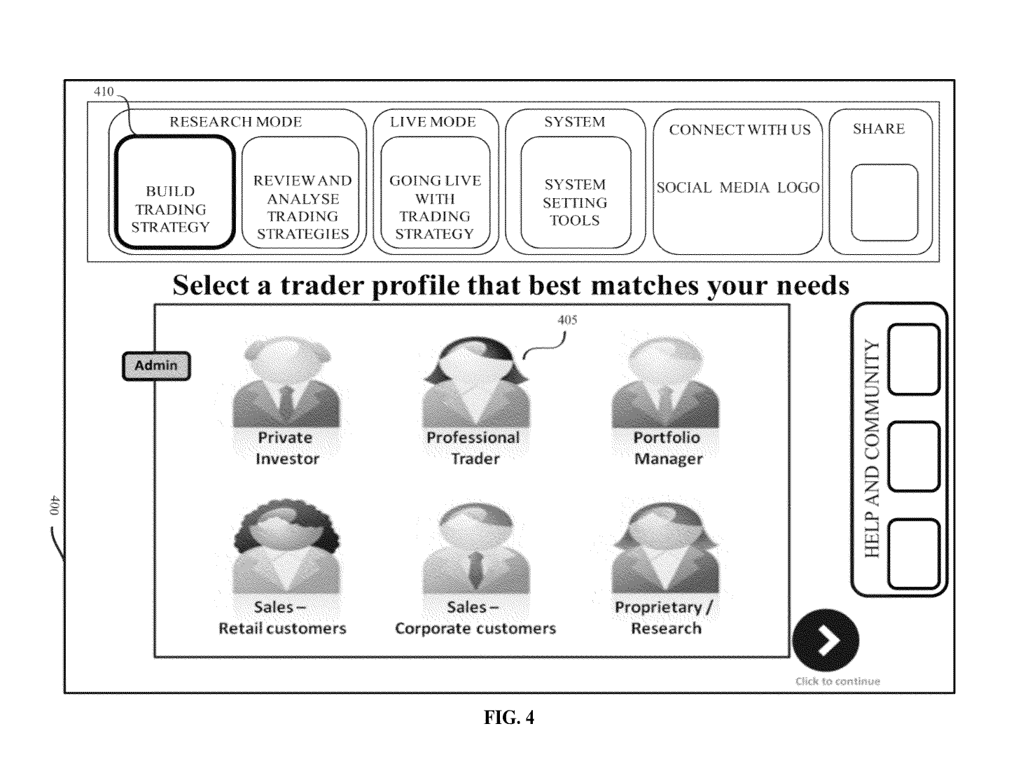

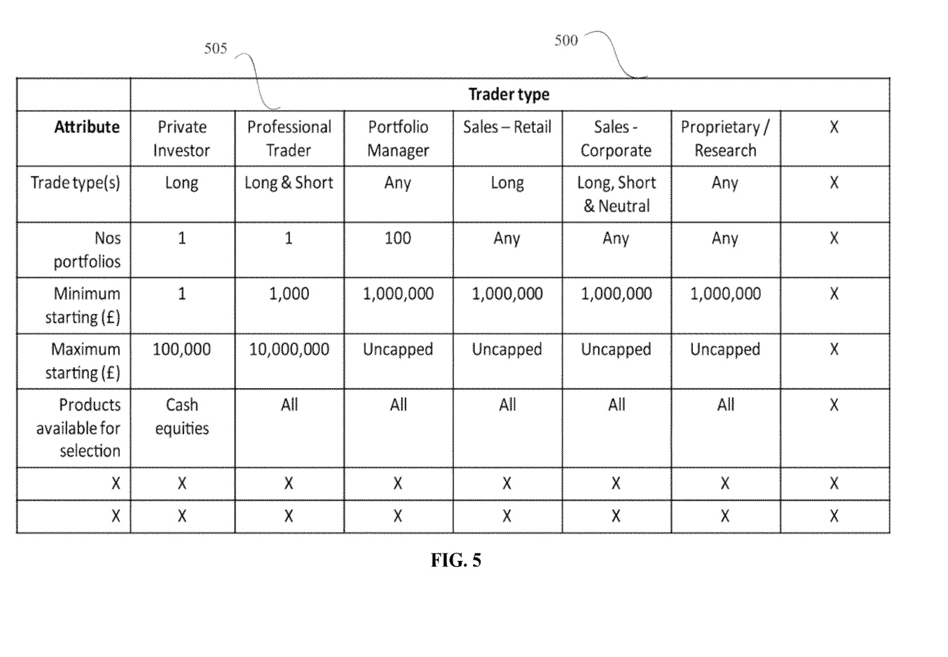

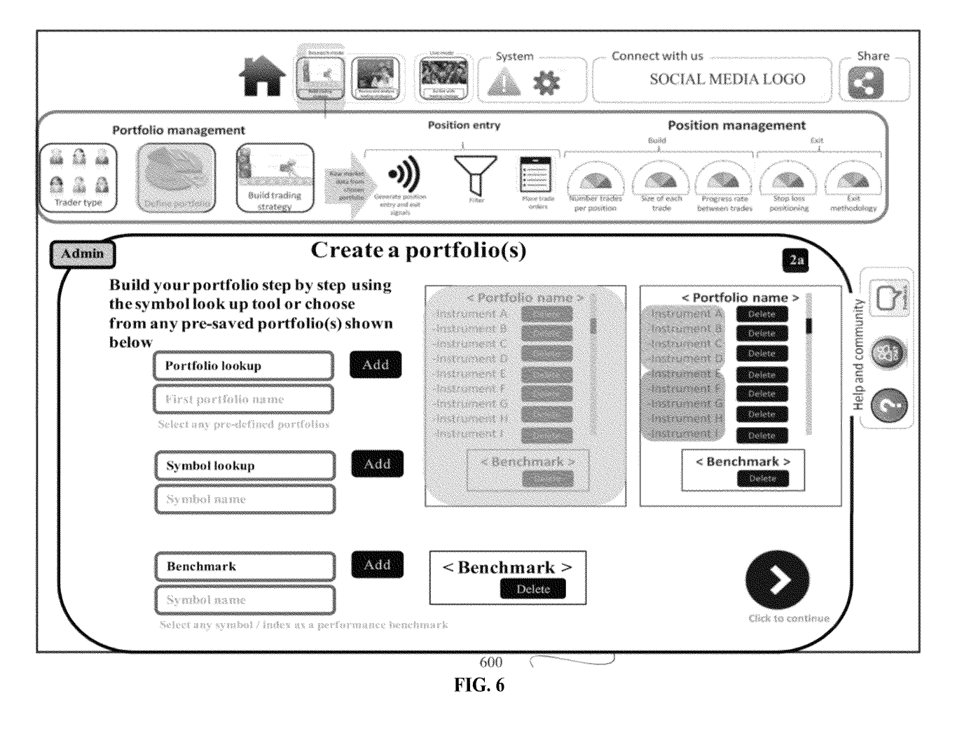

The GUI 300 may be abstracted from all other parts of the system in FIG. 1 such as the portfolio management module 165; the database 155; the transaction server 140; the trading and portfolio manager module 145; etc. Symbols represent any symbol/combination of symbol(s) and context(s) that the user 105 can interpret, interact with and/or otherwise respond to. Further, the component parts of the GUI 300 are abstracted from each other such that, for example, any portfolio created in a GUI 600 (discussed below with reference to FIG. 6), such as FTSE 100 Banking sector shares, may be associated with any benchmark(s) of the GUI 600, such as FTSE 100 Index and NYSE chosen by the user 105 and/or made available for selection by the system administrator. Selections by the system administrator can be based on various criteria (e.g., user 105 selections) such as a mode selected in the GUI 300, a trader profile selected in a GUI 400 (shown in FIG. 4) and the attributes for trader types defined in a GUI 500 (shown in FIG. 5). These relationships/inter-relationships may be defined/predefined by the system administrator at any time such as via editing the attributes for a trader type in the GUI 500 and associating the settings with the trader profile(s) in the GUI 400.

In a preferred embodiment, the GUI 300 may also be designed via a ‘bottom up’ approach, which may be based on an understanding of how to allow an object(s)/symbol(s) respond to any changes/unknown element(s) related to any/all existing system(s)/process(es)/data/structure(s) and/or any combination thereof. An example of a ‘bottom up’ approach may include an unstructured data feed on the Internet such as a social media site (e.g., Twitter®) and stored in the database 155 and that may be filtered such as based on the ticker (e.g., MSFT) and the unique number of users (for those with multiple tweets about the same ticker on any given day) and subsequently structured/re-structured (tagged) according to the outlook on the price of a share such as ‘buy,’ ‘sell,’ ‘hold,’ and ‘unknown.’

By way of example, based on the results (such as one hundred unique Twitter® users of which twenty-five are categorized as ‘buy’; twenty-five are categorized as ‘sell’; fifty are categorized as ‘hold’ and zero are categorized as ‘unknown’), the Interfacing Server 130 generates a shape, such as a pie chart populated with the data and associated time period (day) thus: ‘buy’ (25% pie chart area); ‘sell’ (25% pie chart area); ‘hold’ (50% pie chart area) with associated headings of ‘buy’, ‘sell’, ‘hold’ view for the user 105 to subsequently have available within the process shown in FIG. 2, such as within a review result step 280. The information may be available in a fully searchable/interactive/live update format. Hence, the resulting size, shape, and other features of the symbol(s)/structure(s) are entirely determined by the underlying data characteristics. The interfacing server 130 can be populated with various symbol(s) (such as a bar chart and/or a line graph) by the system administrator and built based on data available in the server 160 and/or the one or more market data providers 120. The populated symbols on the Interfacing Server 130 can be made available for selection by the user 105. Hence, in the preceding example, the user 105 may choose to view the ‘MSFT’ (the official ticker symbol for Microsoft) sentiment data sourced via a social media site as a bar chart and as an alternative to a pie chart view. Any part of the GUI 300 may be programmed/customized by the user 105 and/or the system administrator. For example, a ‘news information symbol/object’ may be programmed by the user 105 to flag as ‘positive’ when a certain word is referenced in a news item ‘merger’ whereas another user 105 may program this event to have a different meaning and potentially a different impact/workflow (discussed below) once the event has been flagged. A flag may take any form such as an audible alert, a change in colour, a combination of events/changes, etc.

Turning now to the process in FIG. 2, an example is shown of a workflow based on the combination of: mode selected (the ‘spread betting’ symbol 305) in the GUI 300; sub category selected (a historical back testing symbol 325) and the data source selected (a data source symbol 330) by the user 105, which subsequently generates steps 220-285. If the user 105 selects ‘education’ mode (the education mode symbol 310), the workflow will be entirely different such as the user 105 only being able to view video(s) and answer questions based on the contents of the video(s) shown to self-assess their knowledge of the content against, a pre-defined computer based grading system. Similarly, if the user 105 selects ‘trading’ mode (the trading mode symbol 315), the workflow would take the user directly to step 285. Similarly, in the GUI 400, the user 105 is able to change the workflow based on a selection made in the menu bar where symbol 410 is highlighted. Hence, in any step within the process shown in FIG. 2, the user 105 is able to move directly to step 285 by choosing a ‘live mode’ in a menu bar of the GUI 400. In this specific example, the user 105 will be able to save their system settings before moving to a step that may not be the next logical step in the workflow they are currently following. At the highest logical level, the system administrator may determine which mode(s) the user 105 is able to view/select and based on the login details provided in step 210 of the process in FIG. 2.

A symbol(s) may be programmed to achieve any interaction/computation/task/programmic action with any part of the system in FIG. 1 and/or any other parts of the process in FIG. 2. The level of user 105 abstraction from any other parts of the system in FIG. 1 may be calibrated by the system administrator and based on the input(s) of the user 105, such as the login details provided in step 210 of the process in FIG. 2. Further, the system administrator may determine, and based on the login details provided, that the user 105 may be presented with the GUI 400 and not shown the GUI 500. However, another user 105 may be shown both the GUI 400 and the GUI 500 and, hence, be allowed to view and/or adjust trader type attributes in the GUI 500 that are associated with any trader profile shown in the GUI 400. Hence, the user 105 of varying technical/skill level(s) is able to execute tasks and/or achieve outcomes of any level of complexity with relative ease such as via an interface that incorporates a series of ‘point and click’ like/non-programmatic interactions within GUI 300. However, not all users may require a ‘help wizard’ to succeed and success with the present disclosure may not depend on the skill level of the user 105.

All aspects of the GUI 300 may be symbolic to maintain user 105 context/familiarity. This may include the help menu; administration consoles and all other associated parts of the process in FIG. 2. Visual/symbolic libraries/collections may be combined in any way and to achieve any type(s) of outcome(s). The GUI 300 may be adapted for any situations via the use of associated and aforementioned context(s) (background images; object labelling/wording/apportioning/subsets; colour scheme(s); measurement; scales; any form of structure(s); process(es)/relationship(s); other symbol(s), etc); any other parts of the process in FIG. 2 and/or combinations thereof. Tasks can be discrete and/or interdependent and/or impact any/all of the features/functions of any other part(s) of the process in FIG. 2 including other symbols and/or context(s).

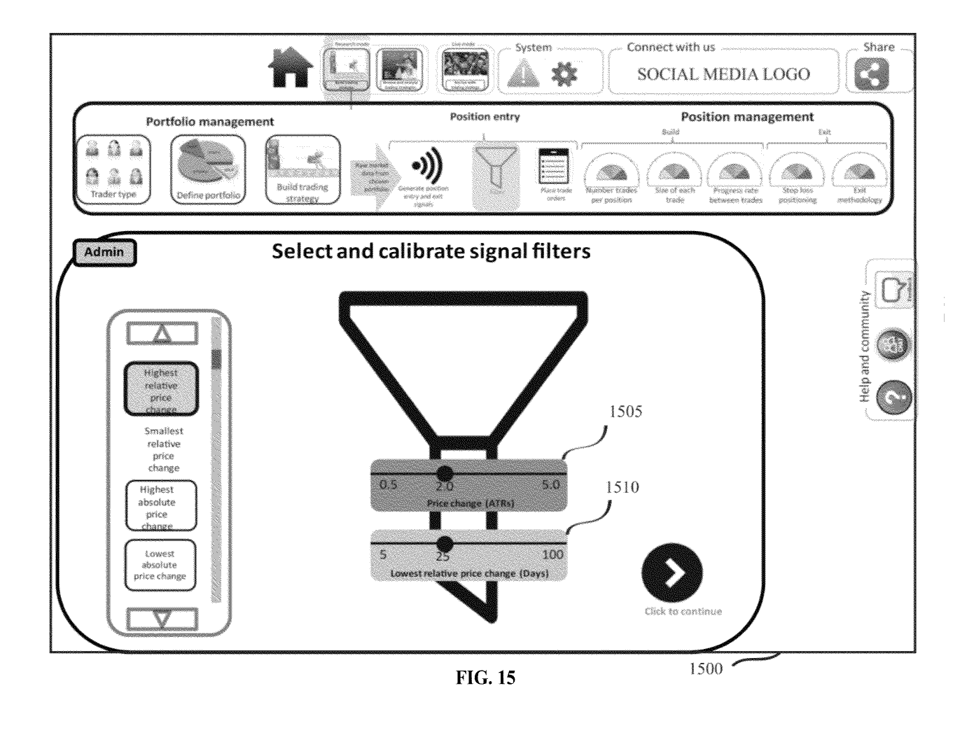

Programmatic command instructions are received, stored and/or executed by the system shown in FIG. 1 and when the user 105 interacts with an object of the GUI 300. For example, in a GUI 1500 (shown in FIG. 15), the user 105 is able to select any available setting for the ‘default price filter’ (default price symbol 1505). For example, the value selected by the user 105 may be any of: 0.5/1.0/1.5/2.0/2.5 . . . 5.0 (in increments of 0.5) and this value is received and stored by the system shown in FIG. 1. When the default price filter (the default price symbol 1505) needs to be calculated, the server 160 multiplies the stored value by the current ATR value for the underlying instrument being assessed. This generates a calculated filter value to add (for long positions) to any calculated ‘entry signal price’ to generate the ‘entry signal filter price’. In this embodiment if the 30-day ATR for instrument yyyy=5 & default price filter (symbol 1505) chosen by user 105=2 and the signal was generated when the closing price for instrument yyyy for that trading day=100, then the calculated ‘entry signal filter price’=100+(2×5)=100+10=110.

These instructions could take the form of a programmatic command/instruction/relationship and as defined between, the part of the symbol the user 105 interacts with and the command(s) associated with that part of the object(s) and that are subsequently executed. The symbols used in the GUI 300 can be pre-programmed to interact with/impact on any other parts of the process in FIG. 2. For example, and extending the example mentioned above relating to GUI 1500 and the user 105 selecting a value for the ‘default price filter’ (symbol 1505). The system administrator is able to enable/disable the secondary filter (symbol 1510) and depending on various factors, such as the user 105 login and/or the value chosen by the user 105 for the ‘default price filter’ (symbol 1505) such as, a value>four disables the secondary filter (symbol 1510). The impact/relationship a symbol may have on any other part/parts of the process in FIG. 2 of the present disclosure may be the direct or indirect. For example, a symbol interaction may directly and/or indirectly impact the appearance or otherwise of another symbol(s) such as a maximum loss calculation or turning, a feature on or off such as filtering.

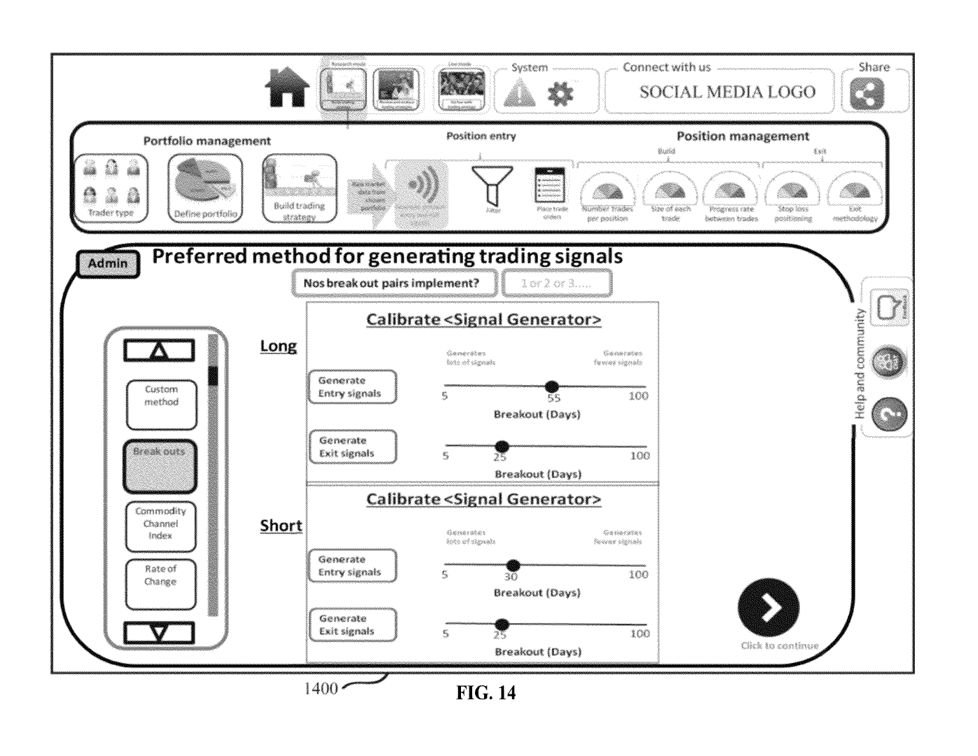

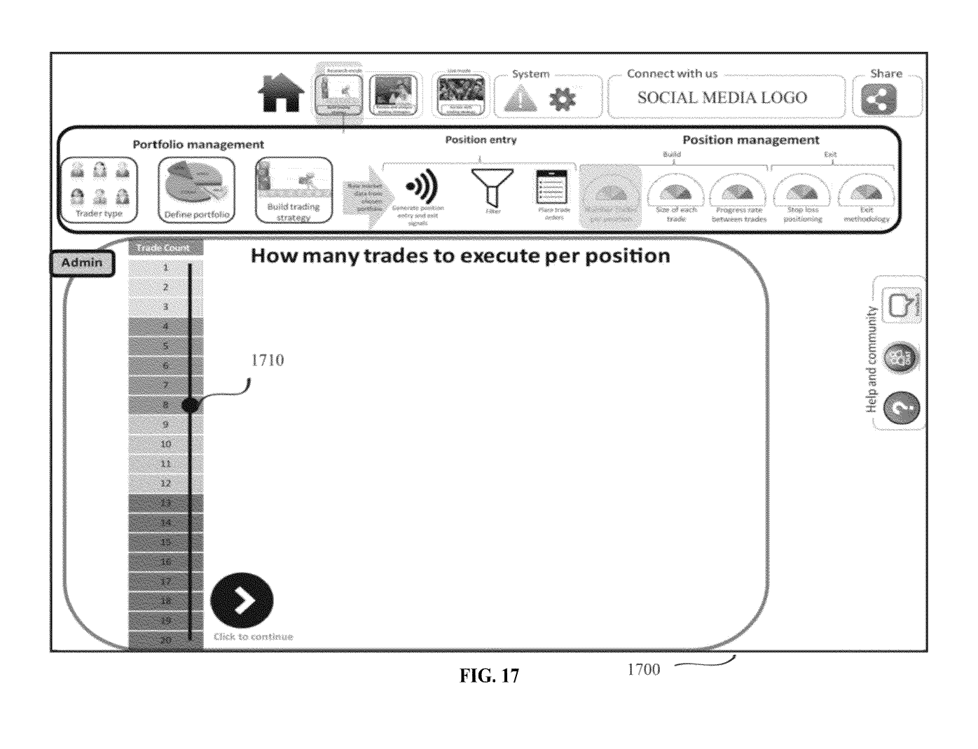

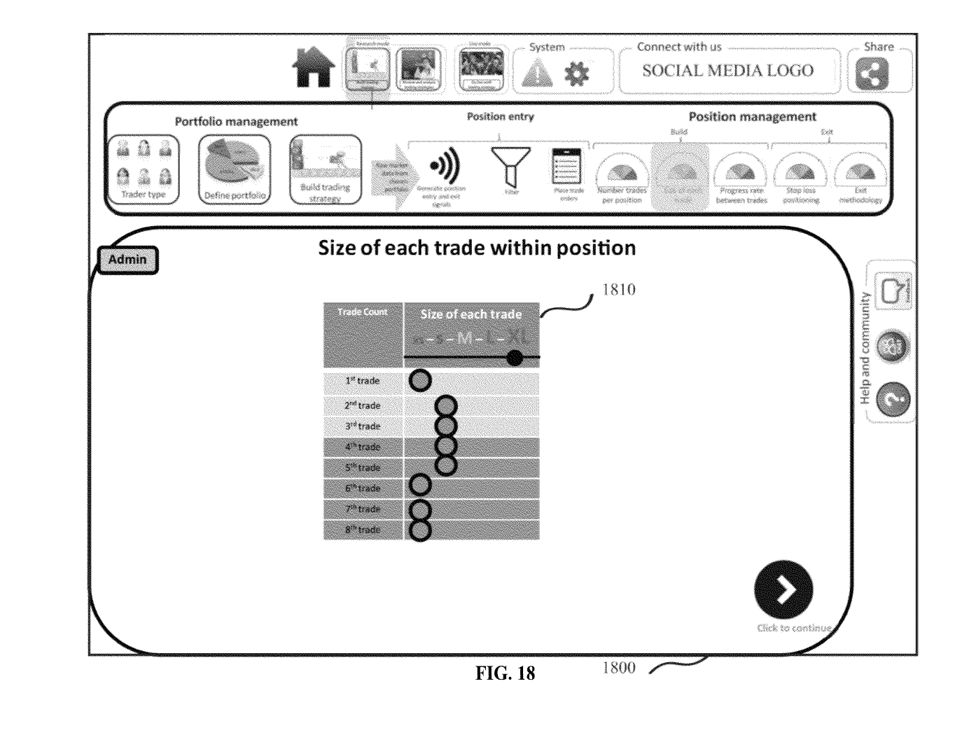

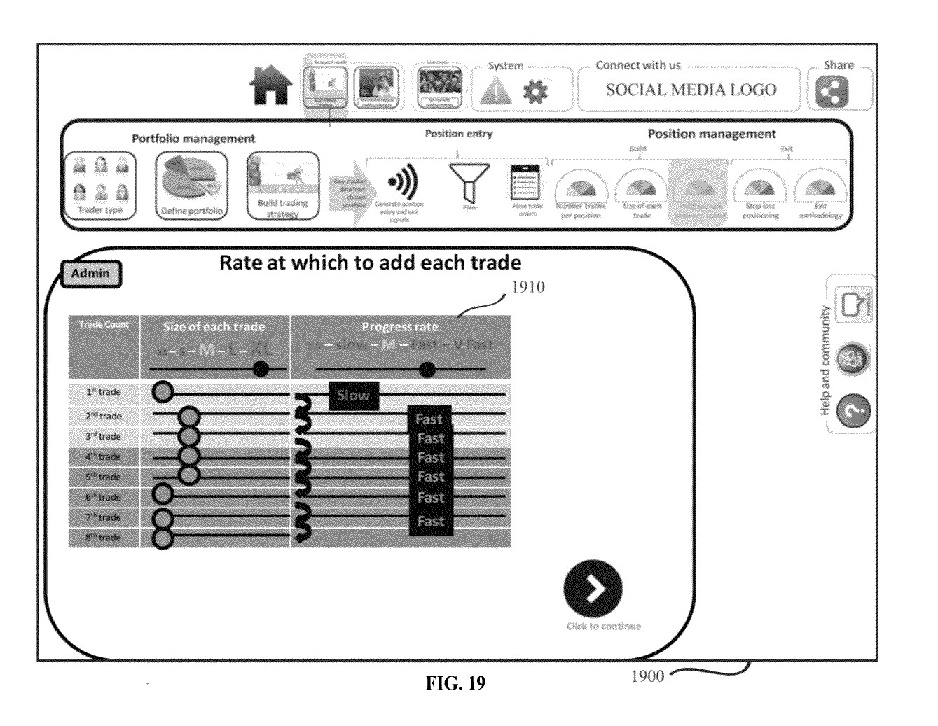

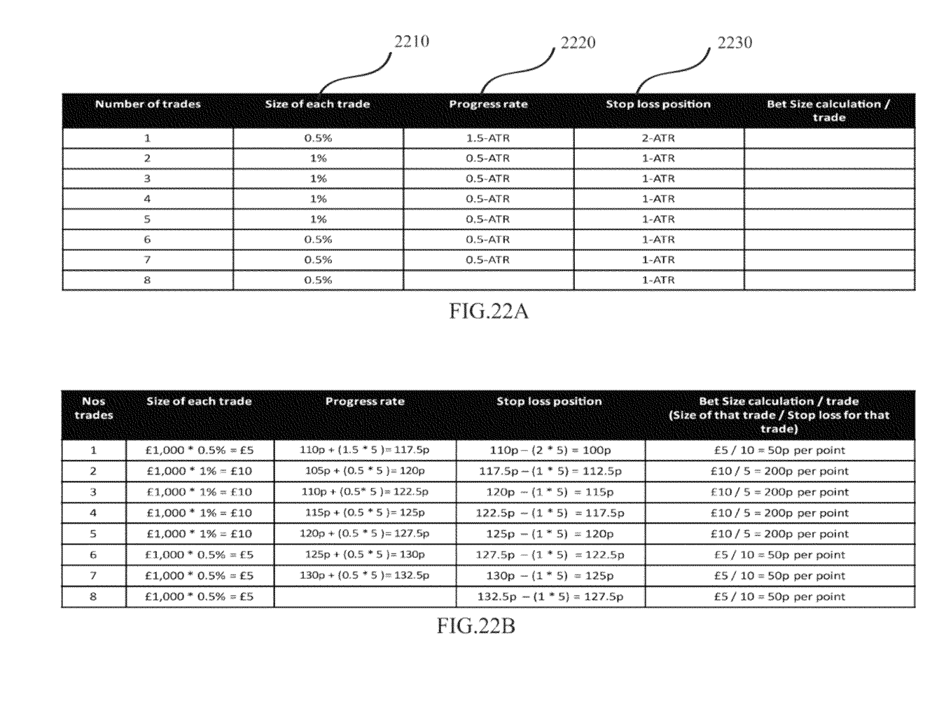

Returning to FIG. 1, the Interfacing Server 130 may acquire, directly, or through a third party, from the one or more market data providers 120, the one or more brokers 125, and/or the database 155 relating to the trade of F.I.'s on one or more exchanges which provide markets for the trading of F.I.'s. The data may be relayed to the client device 110 directly from the one or more market data providers 120 and/or may be stored on the database 155 and retrieved by the Interfacing Server 130 when needed. Actions taken by the user 105 within the trading strategy platform may be translated (see example below) by the Interfacing Server 130 into trade orders, the trade orders may then be performed by: (1) ordering the trades from a broker 125 and/or (2) directly by the trading and portfolio manager module 145. By way of example, translation of actions of the user 105 into a trade order can occur by combining: the trade type GUI 500; a signal generator GUI 1400 (shown in FIG. 14); unique identifier for the instrument concerned and as chosen in the GUI 600 during a portfolio selection; a size selection (a GUI 1700 shown in FIG. 17), a progress rate selection (a GUI 1800 shown in FIG. 18), stop loss position selection (a GUI 1900 shown in FIG. 19), and a bet size as calculated by a table shown in FIG. 22B, into a conventional order string. Orders for trade F.I.s may be performed by the Interfacing Server 130, in conjunction with the F.I., related data analyzer 150, and/or the trading and portfolio manager module 145.

The user 105 can include any number of users and be any type including: human, computer based, robotic, etc. The user 105 can be in any physical location. User 105 may interact with any/all parts of the system in FIG. 1 via any method such as voice; computer based; gesture; touch; biometric; computational; robotic interaction; algorithmic; via body worn computing devices; etc. User 105 may have exclusive use of a session and/or may share that session with multiple users at the same time and with any/all parts of the system in FIG. 1. The user 105 may be allowed to monitor, audit, report on and/or otherwise analyse the interactions of any other user(s) of the system and at any time. The user 105 may be abstracted from all parts of the system in FIG. 1 and/or the process shown in FIG. 2.

This logic part of the system in FIG. 1 lies in the server 160 and it may execute/react to the interaction of the symbol(s) by the user 105 in the GUI 300. The server 160 may interact with any/all parts of the system in FIG. 1. For example, the user 105 interaction with a part of a symbol may instruct any computational/programmatic task(s) either discretely or as part of any other process/task/sequence such as the construction of a trading strategy. All instructions are validated, stored, brokered, managed, and/or otherwise executed in server 160 in conjunction with the client device 110. The exact same symbol(s) and user 105 interaction may initiate any number of different/parallel computational/programmatic task(s) depending on the specific task(s) being achieved and/or context(s) presented. Hence, the system in FIG. 1 is fully extensible to complete/interact with other processes such as accounting; customer relationship management; reporting; analysis; process creation and management; resource management; workflow management; supply chain management; government services; etc.

The disclosure is now described with the help of an example. With reference back to FIG. 2, the process shown (steps 220-285) is based on the previously discussed user 105 selections in the GUI 300 (namely: the ‘spread betting’ mode (the spread betting symbol 305); the sub category (the historical back testing symbol 325), and a data source (a data source symbol 330). As previously discussed, the workflow the user 105 follows may be determined by the system administrator such as by using the login details provided by the user 105 in step 210 of the process in FIG. 2. Similarly, the workflow may also be determined by the selection(s) made by user 105 in the GUI 300. Hence, the process in FIG. 2 may take various forms, follow a different sequence and/or be structured in a different way based on user 105 selection(s) in GUI 300 and/or system administrator setting(s). For example, it is possible to allow the user 105 and/or the system administrator to construct their own process/workflow. In this instance a governing workflow manager module would ensure that any generated process remains logically robust and mathematically valid and based on all the variables selected e.g. not allow settings for number of trades*size of each trade>100%. Another example may include ensuring a valid structure is defined, e.g., when defining a mode in the GUI 300 making sure the relevant attributes are assigned for that object type such as the historical back testing symbol 325 and the data source symbol 330 of the GUI 300.

The user 105 logs on to the GUI 300 shown in FIG. 3 on the client device 110, as in step 210. Now the user 105 has the option to select any of the modes GUI 300, as in step 215, for example, ‘spread betting’ mode, ‘education’ mode or ‘trading’ mode presented as the symbols 305, 310 and 315 respectively in the GUI 300. For example, the process in FIG. 2 is based upon ‘spread betting mode’ (symbol 305) and in the sub category ‘historical back testing’ (symbol 325) & connecting to a data source ‘EOD-OHLCV’ (End of Day data in the format Open/High/Low/Close/Volume), symbol 330. Categories and sub categories may be of any number and/or may vary between mode(s).

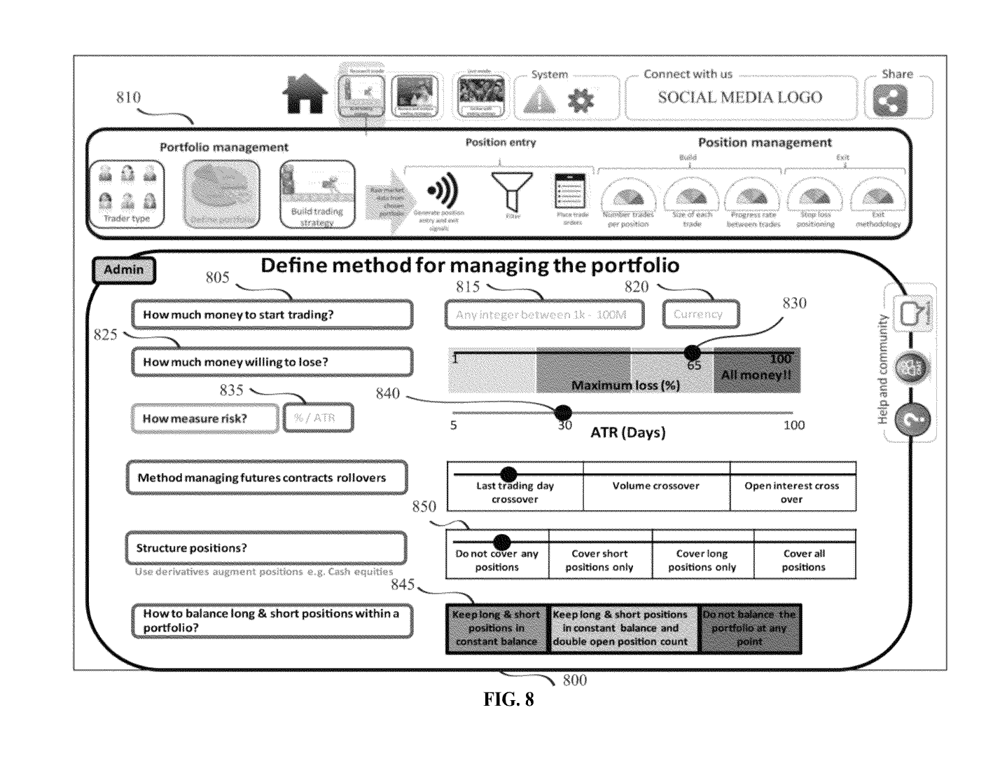

In a preferred embodiment, the mode chosen by the user 105 impacts any/all parts of the GUI 300; the sequence and number of steps in a workflow/process; and/or any/all options available to the user 105. For example, if the user 105 chooses ‘trading’ mode (symbol 315) then portfolio management (GUI 800, FIG. 8) would appear before portfolio selection (GUI 600, FIG. 6) if the system in FIG. 1 was set to cater for contract sizes. For example, only cash equity products would be shown as available for selecting within the portfolio (GUI 600, FIG. 6) where the user 105 selects a ‘how much money start trading’ value, <=1,000 GBP (currency equivalent for non-GBP currencies and using daily spot FX rates for the conversion on the day the test was executed). The system in FIG. 1 may be set to thresholds, such as ‘how much money start trading’ (symbol 805, GUI 800, FIG. 8) value>100× minimum exchange published contract value for any F.I. Any F.I. that does not meet these criteria is not made available to the user 105 for inclusion in their portfolio. The thresholds may be set to any value. The ‘how much money start trading’ may be set to any value by the user 105 and relative to the trader profile they have chosen. In the present example, the user 105 selects a trader profile of “Professional Trader”, symbol 405 on screen 400, FIG. 4.

‘How much money to start trading’ (symbol 805, GUI 800, FIG. 8) and other trader type attributes may be stored in a table such as table 500 shown in FIG. 5. Any profile type may be created (FIG. 4) with any type/combination of attribute(s) (FIG. 5), hence making this and all other parts of the process in FIG. 2, fully extensible in every possible way.

Further, for example, if the user 105 chooses, ‘trading simulation mode’ (symbol 315, FIG. 3) then portfolio management (GUI 800, FIG. 8) conducts a market liquidity assessment based upon the user 105 choice of ‘how much money start trading’ whereby value daily volumes for any instrument must never <=100× trade size for that specific portfolio.

The system administrator of the system in FIG. 1 may set these and other attributes/system settings/thresholds to any value. Any time the system in FIG. 1 reaches these limits then the process in FIG. 2 may be designed to take any actions such as (a) split trade exits into even smaller orders; (b) spread exit orders across multiple brokers; (c) cease trading that instrument; (d) re-allocate monies to other parts of the portfolio(s); (e) initiate an exit over a period of time to correspond with current volumes for the instrument(s) concerned; etc.

The user 105 may move (forwards and backwards) between screens to review, change, edit or otherwise update any/all settings. It should also be noted that any/all parts/settings/components within the server 160 are stored and are available for search, sort, filter, etc and also as objects for any other computational functions such as ‘portfolio name’ which stores all the instruments that are part of that portfolio. By way of further example, ‘portfolio name’ could be appended with, a date time stamp; hence all versions of that specific object are also fully available to the user 105 of the system in FIG. 1.

The ‘admin’ (symbol 320, GUI 300, FIG. 3) box indicates that via the system administrator console of the GUI 300 including screen layout and options may be changed in any way to meet different user 105 requirements, e.g., only show the education option (symbol 310, GUI 300, FIG. 3) to a group of users with the subcategory ‘Historical Back-testing’ (symbol 325, GUI 300, FIG. 3).

There may be any number of users 105 interacting with the system of FIG. 1 at any time. And it is possible to group and/or otherwise organize and monitor/control/govern the manner in which any number of users 105 interact with the system in FIG. 1 e.g. apply portfolio limits to a group of users 105. In this embodiment the system in FIG. 1 is in use by a single user 105. The user 105 is able to select a trader profile GUI 400 as in step 220 of FIG. 2. Any number of profiles may be set up and managed by a single user 105.

Any number of trader profiles GUI 400 may be created and as illustrated in FIG. 4. In this embodiment ‘Professional Trader’ profile 405 is selected by the user 105. The highlighted symbol 410 shows that the GUI 400 is in “build strategy” mode of the research mode.

The trader profiles GUI 400 may have any combination of different capabilities/attributes. Any attributes may be created and/or assigned in any combination to any trader type. For example, a ‘Private Investor’ profile may only allow the user 105 to trade ‘long’ positions only e.g. ‘buy low’ and ‘sell high’; whereas a ‘Professional Trader’ profile may allow the user 105 to trade both ‘long’ and ‘short’ e.g. additionally ‘sell high’ and ‘buy low’. The trader profiles GUI 400 may work with any/all other parts of the process in FIG. 2. It should also be noted that each trader profile GUI 400 may have a unique interface and/or different sequence of tasks to complete in order to achieve an outcome (build and test their strategy).

The trader profiles GUI 400 are a good example of items stored within the server 160 and that are available for search, sort, filter, etc functions for the user 105 as illustrated in FIG. 1.

A table 500, as shown in FIG. 5, is an example of a range of settings for allowing any authorized system administrator to create, change or otherwise modify any/all trader profiles GUI 400 and/or their assigned attributes. Parts of the process in FIG. 2, such as step 225 may be structured/integrated/extended in any way such as combining the portfolio selection with statistical studies, such as a correlation study and which is automatically triggered when the user 105 selects a portfolio comprising of set of instruments from a single asset class. Implementation may take any form such as automatic or by selection of the user 105 from the GUI 300.

In this embodiment, a column 505 is applicable based on the ‘Professional Trader’ user 105 selection shown in GUI 400. Once the selection has been made, the user 105 progresses to the GUI 600 in FIG. 6.

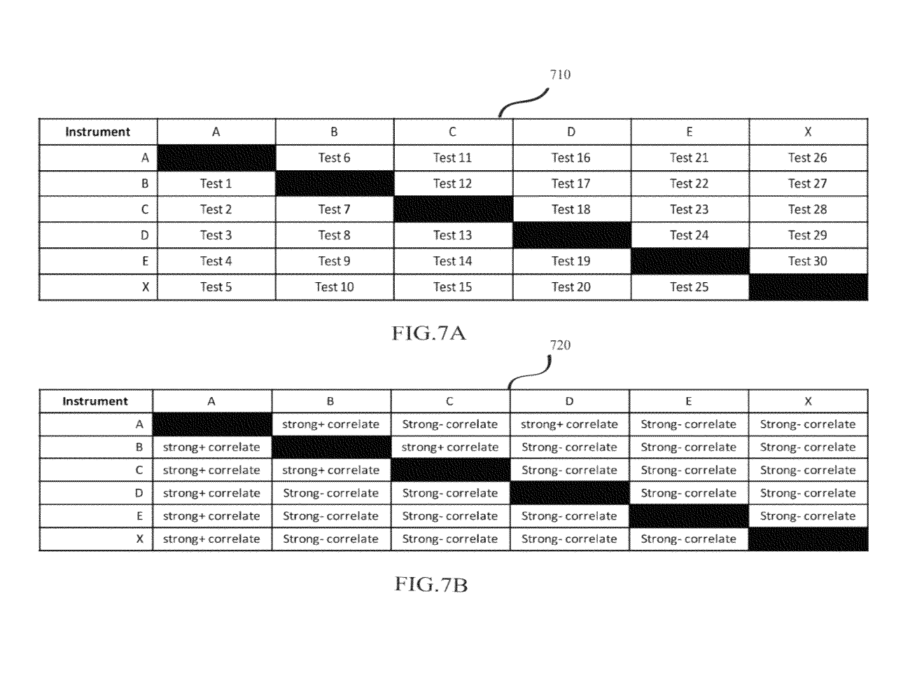

Reference to FIG. 1, FIG. 2, FIG. 6, and FIG. 7, as in step 225 of FIG. 2, the GUI 600 is presented by the system in FIG. 1 of the present disclosure wherein the user 105 gets the option to create a portfolio by interacting with the various symbols available in GUI 600. The manner in which portfolio creation options are made available on the GUI 600 may be influenced by other choices made within the process in FIG. 2 such as, trader profile GUI 400. In other modes (the present example is for ‘spread betting mode’) this GUI 600 may appear later in the process in FIG. 2. The user 105 is able to select either a pre-defined portfolio(s) (e.g. Exchange defined such as an entire index—FTSE 100; index sector—FTSE 250 Banking sector; etc) such as one built by the system administrator; other users 105 and/or one that the user 105 may have previously created. These may be of any composition and subject to any restrictions imposed by the system administrator, e.g., as defined in trader type attribute table in FIG. 5. Different product/instrument types within a single portfolio may be shown differently, e.g., use of different colours for equities versus Foreign Exchange (FX) instruments. The portfolios may be of any number, size and/or composition, e.g., equities; FX; Bonds; Commodities; cash products; derivatives; etc. The options available for the user 105 to select are based on the trader profile GUI 400 selected. For example, a ‘Private Investor’ trader profile GUI 400 may only allow the user 105 to select cash equity instruments only, such as to meet regulatory requirements in a jurisdiction. A ‘professional trader’ trader profile GUI 400 may be able to select more instruments and/or portfolio subcomponents such as futures contracts.

Additionally, the user 105 may select any number of benchmarks to use for comparison purposes. These benchmarks may be set at a portfolio level and across any/all portfolios selected. Like all systems components portfolios and their associated benchmark(s) are assigned a default value for reference by other parts of the process in FIG. 2, e.g., username-P′n′B′n′B′n′ where ‘username’ is the name of the user 105; ‘P’ is an abbreviation for ‘Portfolio’; ‘n’ is a logical and incremental count; ‘B’ is an abbreviation for ‘Benchmark’.

In some embodiments, the portfolio selection may trigger an automatic correlation study. For example, this involves the following steps for each portfolio created (using the example of a five instrument portfolio shown in a table 705 in FIG. 7A):
1. Create a table for each portfolio with constituents across both dimensions of the table 705 in FIG. 7A.
2. Conduct correlation tests (not necessarily in the order shown in table 705 in FIG.7A) and record results within the system in FIG. 1, e.g., the process in FIG. 2 may be set to calculate a ‘strong positive correlation’ as any positive test result greater +75% and a ‘strong negative correlation’ as any negative test result greater than −75%. All other test result values may be categorised as ‘not correlated’ and/or in any other manner/sub categories as required.
3. These results are stored in the system in FIG. 1 for reuse although not necessarily in the exact format shown in table 710 in FIG. 7B.

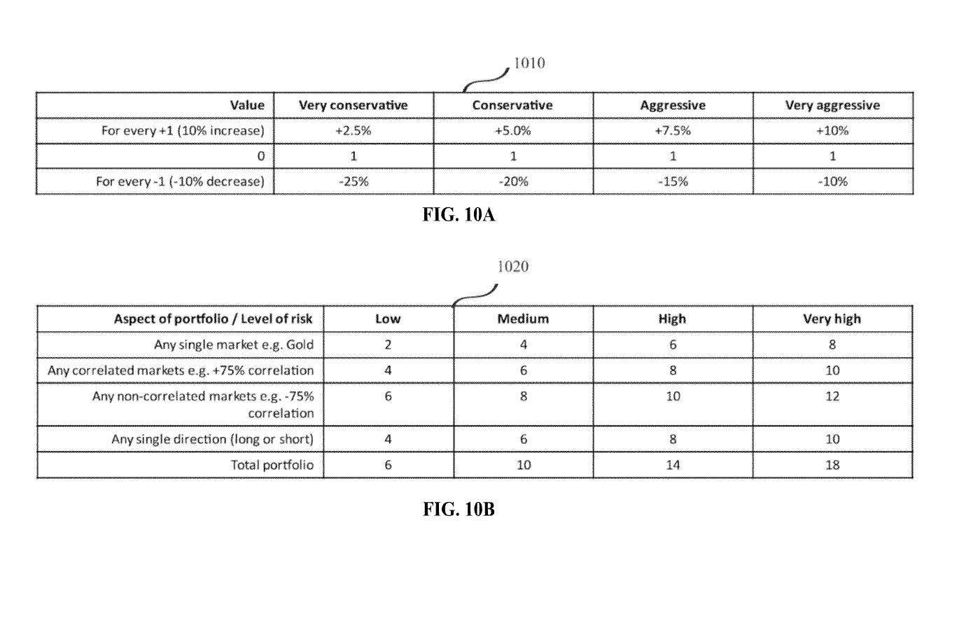

The GUI 600 of FIG. 6 can be used to determine:
1. What is the current ‘systems definition’ of a strong and/or negative correlation perhaps via a sliding scale of percentages, e.g., the system administrator may choose any setting from +70% to +100%/−70% to −100% for both individual results (such as those shown in the previous table 710 in FIG. 7B) &/or at a portfolio level (see (2) below and as measured in absolute terms)
2. What is the current ‘systems definition’ of a strong and/or negative portfolio correlation perhaps via a sliding scale of percentages e.g. the system administrator may choose any setting from +70% to +100%/−70% to −100% and calculated thus (using the prior table 705 in FIG. 7A)
   1. Sum total correlation tests conducted: (30)
      1. Nos classified as ‘Positive Correlation’ (based on current systems settings in (1) above) (9)
      2. Nos classified as ‘Negative Correlation’ (based on current systems settings in (1) above) (21)
   2. If the Portfolio correlation limits test was just to assess ‘negative correlation’ and the settings were set at, 80% then the portfolio would be deemed as not ‘negatively correlated’
   3. The system administrator may then have the process in FIG. 2 classify the portfolio be treated as ‘positively correlated’ & this setting is shown in the exemplary embodiment of the present disclosure.
3. The system administrator may decide to allow the user 105 to determine their own correlation settings.
4. The system administrator may also decide to allow correlation analysis to be conducted by the process in FIG. 2 in real-time and based on current exposure. For example, if the current portfolio comprised 100% instrument ‘E’ and then added instrument ‘A’ then based on the correlation table the portfolio would be classified as ‘negatively correlated’. If instrument ‘B’ was added to the portfolio then the portfolio would retain the current classification. Correlation analysis may also be combined with other aspects of the process in FIG. 2 such as size of position and the number of trades associated with each position. The results of any such analysis may also impact any other parts of the process in FIG. 2 such as the portfolio limits (FIG. 10B).

Once these selections have been made the user 105 is taken to GUI 800 as shown in FIG. 8.

In this example the user 105 is shown and taken through a workflow as illustrated in the black rectangular navigation bar 810 shown at the top of the GUI 800 as shown in FIG. 8. On this screen the user 105 is able to insert the amount of money they have to start trading and the base currency of those funds. This may be used in other calculations such as those associated with the Trader Type attributes table 500 shown in FIG. 5. This defines the user 105 ‘starting capital’. For example, in this embodiment the user 105 selects 1,000 in box 815 and a base currency of Great Britain Pound (GBP) in box 820. The user 105 is able to select the ‘amount of money they are willing to lose’ in box 825. This is merely moving the slider 830 to any number from 1-100 and as measured in percentage terms. This completes the following calculation: % selected*‘start capital’, so if 10% is selected and 1,000 GBP was chosen then the result recorded for these selections is 100 GBP. In this embodiment the user 105 selects 65% which equates to £650.

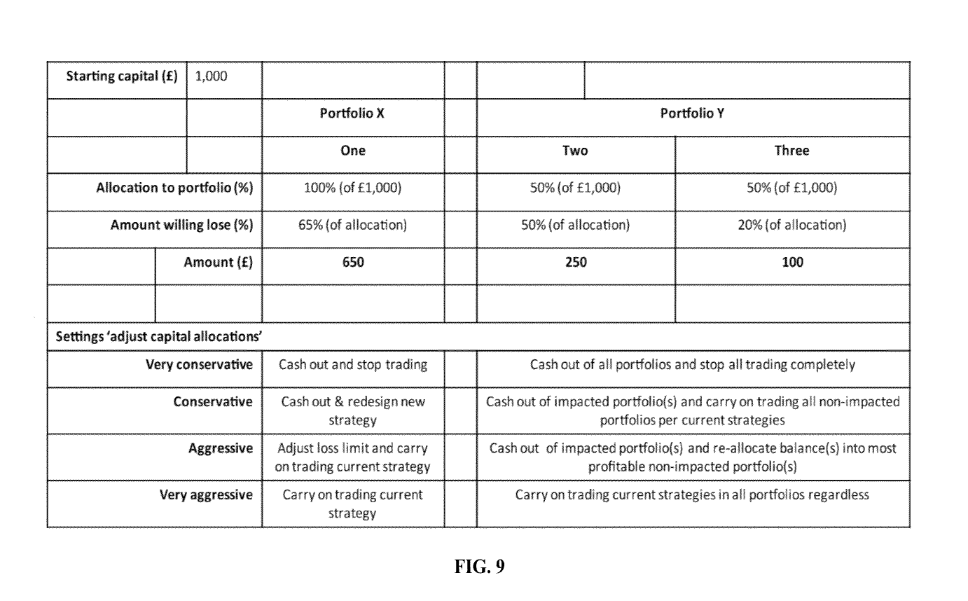

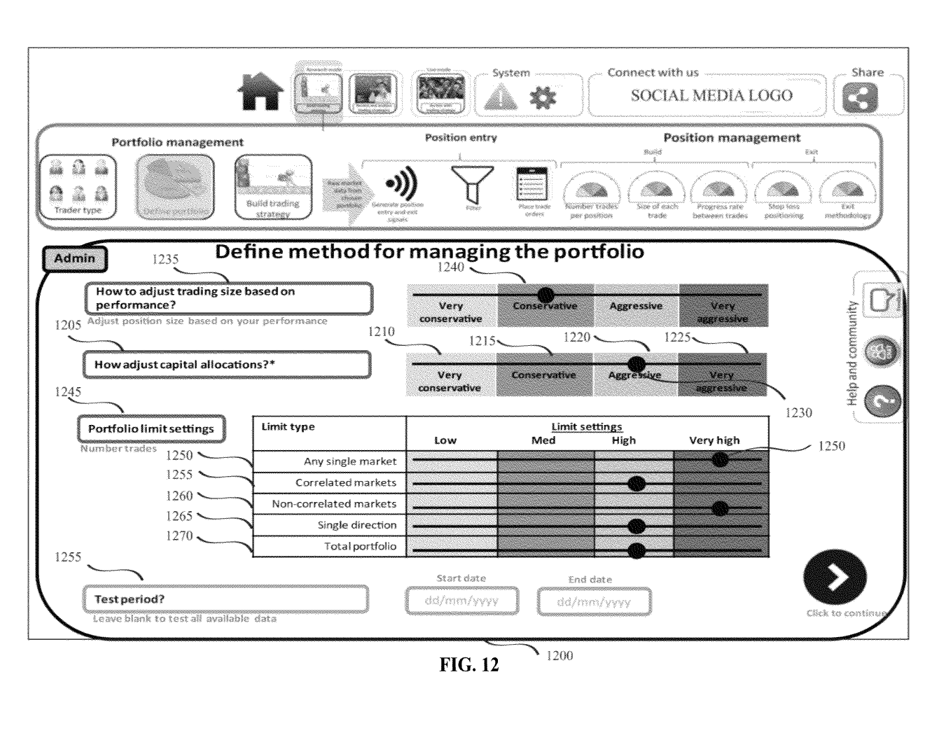

The user 105 is able to select the ‘adjust capital allocations’ 1205 on GUI 1200 of the GUI as shown in FIG. 12. This is moving the slider 1230 to any of the positions available such as the 4 positions currently shown e.g. ‘very conservative’ 1210; ‘conservative’ 1215; ‘aggressive’ 1220; ‘very aggressive’ 1225. The selection completes the calculation shown in table 900 as in FIG. 9. In this case the single portfolio example applies (portfolio X). In this example the user 105 selects ‘aggressive’ 1220.

The rules are governed by the table settings shown in a table 900 of FIG. 9 which may be set to any logical values. For example, in the sequence shown the table 900 is constructed such that allocations are split evenly across all portfolios created such as the 2 created within portfolio Y. This ensures logical integrity to underlie any user 105 selection (shown at the bottom of the table 900). Hence, if at any time the current value of the portfolio <£650 the user 105 will be prompted to adjust the ‘amount of money they are willing to lose’ (%) to a greater percentage than 65% & a greater % than the current value of the portfolio.

“Adjust position size” 1235 is based on the following calculations. In this embodiment the user 105 selects trading size “conservative” 1240 on GUI 1200 as shown in FIG. 12.
1. At the end of each trading day the portfolio(s) is ‘marked to market’ [M2M] based on closing price data for that market and time zone. And for global portfolio(s) this may also include the ‘spot price’ for any currently trading instrument(s). In ‘spread betting’ mode this means calculating, the [bet size per point*current point value]−[bet size per point*entry point value]. Repeat this calculation for all open positions. Then add this to the original ‘starting equity’ value (very first time) or the prior ‘current equity’ value. This is then the M2M value for any given day.
2. Then [daily M2M value/original starting equity value]*100%=value, 125% [M2M %]
3. Before entering any position the following is done:
   1. Exit all positions and associated trades as per the exit methodology
   2. Then check/recalculate the M2M % value for current day=M2M %−100%=25% (value). Divide this ‘value’ by 10=25%/10=2.5. Round DOWN=2
   3. Look up the table 1010 as in FIG. 10A and apply the calculation.
   4. So, for a ‘conservative’ user 105 selection in this example, calculate 2*5%=10% and then apply this factor to all applicable trades in the position manager table.
   5. All the values set in the table may be adjusted to suit in any way. M2M is a sample calculation.
   6. Adjust portfolio trade limit settings 1245 shown in FIG. 12 and these become the systems values associated with the user 105 selection based upon their interaction with the plurality of sliders 1250 on GUI 1200 as shown in FIG. 12.

In this embodiment the user 105 selections are shown in the table 1020 of FIG. 10B.
1. Before entering any position the following checks are run which may be done in sequence & in terms of current open positions (‘very conservative’ chosen by way of example for all settings as in GUI 1200, FIG. 12):
   1. (Total portfolio 1270) In terms of total portfolio exposure if user 105 has the equivalent of 14 current open trades in any direction then the trade entry signal ignored, else next filter assessed.
   2. (Single direction 1265) In terms of ‘direction exposure’ if the user 105 has the equivalent of 8 current open ‘long’ or ‘short’ trades then the current trade entry signal ignored if it is ‘long’ or ‘short respectively, else next filter assessed.
   3. (Non-correlated 1260) In terms of ‘non-correlated exposure’ & where deemed relevant by the portfolio correlation study if the user 105 has the equivalent of 12 current open & non-correlated trades then the trade entry signal is ignored, else next filter assessed.
   4. (Correlated 1255) In terms of ‘correlated exposure’ if the user 105 has the equivalent of 8 current open & correlated trades then the trade entry signal is ignored, else next filter assessed.
   5. (Single market 1250) In terms of ‘single market’ if the user 105 has the equivalent of 8 current open trades then the trade entry signal is ignored, else the trade against the filters set assessed.

The user 105 is able to select any method of measuring risk such as using a percentage or the ‘Average True Range-ATR’ in box 835 as methodology shown in GUI 800 of FIG. 8. The user 105 is then able to select any setting (days) as ‘n’. This is merely by moving the slider 840 to any of the positions available such as those positions currently shown e.g. any number from 5-100 (days). The scale may vary for this specific method and/or for any other methods available to the user 105. The number selected ‘n’ is then used to set the cell range for the calculation e.g. the previous ‘n’ trading days calculate the ATR using ‘n’ as the divisor for the calculation. These daily numbers are recorded within the server 160 for future use. In this embodiment the user 105 selects ‘ATR’ and a setting of 30 (days). The chosen (30) variable is used as the day count in the ATR calculation and all its variations. In this embodiment the system in FIG. 1 uses an exponential moving average method of calculating ATR.

The user 105 is able to select methods for managing the portfolio such as monitoring long and short positions. In this specific example, as in GUI 800, FIG. 8 the user 105 is able to select either (a) ‘keep long and short positions in constant balance’; or (b) ‘keep long and short positions in constant balance and double open position count’; (c) ‘do not balance the portfolio at any point’ as shown in box 845. This means from a position entry perspective (& subject to all portfolio limits set): (a) take the next position entry signal(s) if they balance the portfolio's current open positions e.g. from, 1 long and 2 short positions to 2 long and 2 short positions; (b) where in (a) we decide to only enter and exit positions in pairs (long and short) we may choose to also double the open position count. This may be implemented as a doubling of the portfolio limit set & hence, acting as an override to that specific setting and making the user 105 aware of such changes/impact of their choice; (c) take every signal available regardless of direction. In this embodiment the user 105 selects (c) take every signal available regardless of direction [subject to the portfolio limits set].

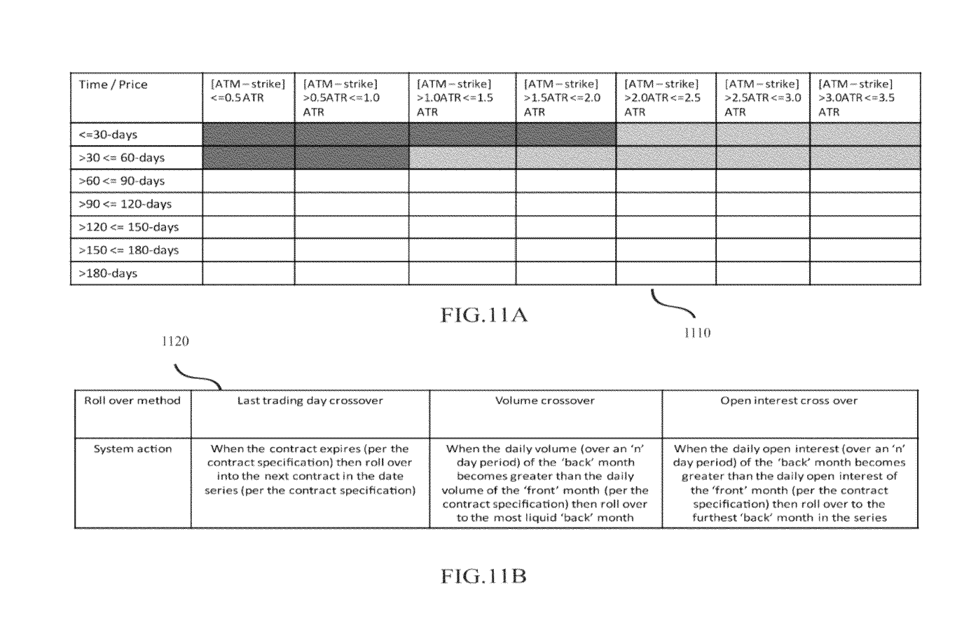

The user 105 may structure positions in any way such as covering trades in any combination. Where the user 105 selects cover all trades then the position is appraised against the table 110, FIG. 11A: note the process in FIG. 2 defaults to the relevant area of the table depending on the strategy adopted (none of the settings apply in this embodiment). These systems and settings may be changed at any time. Also the price and time scales are infinite and may be changed to any price and/or time parameters to suit. In this embodiment the user 105 selects not to cover any positions (“do not cover any positions” 850).

Where options are available to trade, such as for a US equity, each 100 shares purchased at, 100 pence with an entry ATR of 5@ 1^{st} January, then the process in FIG. 2 will automatically initiate a single (‘buy write’) call option contract sale for that equity position at a strike price of at least 2.0*5=110 pence within the current expiry month/up to a maximum of 60 trading days away). If the position remains open when the option expires then the process in FIG. 2 does not initiate a contract rollover unless specified. If an option contract is not available with these parameters then the process in FIG. 2 will not initiate a ‘write’. Position logic may be combined with any other parts of the process in FIG. 2. For example, when a ‘write’ is initiated a margin accounting ledger is opened and managed for that position with corresponding changes made to current account equity; etc.

Manage roll-overs (for futures contracts) will be based on the table 1120, FIG. 11B. In this embodiment the user 105 selects ‘Last day trading crossover’

The user 105 is able to select any combination of start and/or end date(s) for their test or leave these fields blank in box 1255 on GUI 1200 to test the entire data set. In this embodiment the user 105 leaves these fields blank to test the entire data set.

The user 105 is able to name their test else the process in FIG. 2 will revert to any default naming convention such as a time-date-version stamp.

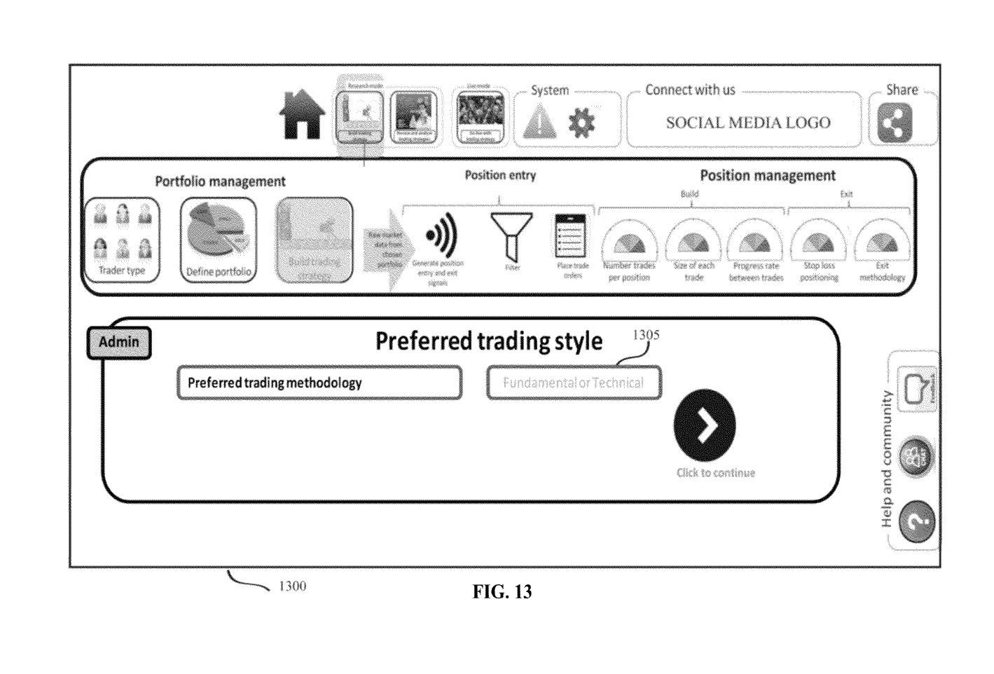

This completes creation of portfolio as in step 225 of FIG. 2 and the user 105 is taken to GUI 1300 as in FIG. 13.

On GUI 1300, FIG. 13 the user 105 is able to select their trading style as either ‘fundamental’ or ‘technical’ in box 1305. This selection then determines the methodology workflow to allow the user 105 to design the trading strategy aligned to their chosen preferences.

The user 105 may then be presented with a submenu from which to choose a specific method from, for example, Fundamental trading methods list: such as ‘earnings reports’; ‘stock splits’; reorganizations; acquisitions; etc. Technical trading methods list: such as Candlestick; Breakouts; etc. ‘Breakouts’ in this case is chosen (as shown in FIG. 14) by the user 105.

The following is based on a ‘technical trading method’ selection by the user 105 and specifically ‘breakouts’.

This marks completion of trading style selection by the user 105 as in step 230 of FIG. 2. Trading styles may be of any type and the user 105 may select any number &/or combination of trading styles.

Once the trading style selection has been made the user 105 is taken to GUI 1400 of FIG. 14.

On GUI 1400, FIG. 14 the user 105 is able to select from the library of ‘technical’ signal generation methods available in order to generate a trading signal. This selection then determines the methodology workflow to allow the user 105 to calibrate their chosen signal generator(s). The list may be of any signal types, even customized ones. The ones shown in GUI 1400 are related to user 105 prior choice of ‘technical trading methodologies’ (GUI 1300). In this exemplary embodiment of the present disclosure the ‘break outs’ method of generating signals is the only option selected.

The signal generator may be applied in different ways to generate trade entry and exit signals. The number of signals selected to work in tandem may vary such as 2 signal pairs to trade in parallel such that the first signal pairing may be, 30-days ‘in’ & 10-days ‘out’ and the second parallel signal pairing may be, 55-days ‘in’ & 25-days ‘out’. Alternatively or additionally a pairing may be split across trade types (such as the one shown) which is (for long positions) 55-days ‘in’ & 25-days ‘out’ and (for short positions) 30-days ‘in’ & 25-days ‘out’. This then drives the calculation shown below.

The signal generator may be applied in different ways to the entire portfolio and/or specific parts of the portfolio.

The signal generator may be applied in different ways for ‘long’ and ‘short’ positions.

The process in FIG. 2 takes the selected values for ‘entry’ (Ne) and ‘exit’ (Nx) for long positions and evaluates the ‘closing price’ (any price could potentially be used) for each relevant portfolio instrument where:

For long position signals:

For the prior (Ne) days assess whether today's close was the highest closing value for that instrument, if so then return ‘BTO(Ne)’

For the prior (Nx) days assess whether today's close was the lowest closing value for that instrument, if so then return ‘STC(Nx)’

For short position signals:

For the prior (Ne) days assess whether today's close was the lowest closing value for that instrument, if so then return ‘STO(Ne)’

For the prior (Nx) days assess whether today's close was the highest closing value for that instrument, if so then return ‘BTC(Nx)’

The appending of (N) to each signal allows different signal generation methods to be differentiated when assessing signal types.

As shown in FIG. 14, GUI 1400 illustrates the potential settings for this specific generator type for long positions only and within the scale of 5-100 (days) shown. And only one generator is working not two. These closing prices may be set as ‘entry signal prices’.

The process in FIG. 2 of the present disclosure may adopt a signal naming convention to encompass any/various systems parameters such as,
UserName (Xxxx)
Portfolio and associated benchmark setting (P1B1)
Signal Generation Type (BO—for Break Outs)
Direction (BTO or STO)
Signal setting(s) (55 for BTO & 30 for STO respectively)
Instrument (Unique identifier for each portfolio instrument e.g. yyyyy)
Hence, for the embodiment shown the process in FIG. 2 would generate the following naming taxonomy for signals generated

### (Long Positions)

Xxxx-P1B1-BO-BTO-55-yyyyy
Xxxx-P1B1-BO-STC-25-yyyyy

### (Short Positions)

Xxxx-P1B1-BO-STO-30-yyyyy
Xxxx-P1B1-BO-BTC-25-yyyyy

Thus, trading signals are generated as in step 235 of the process in FIG. 2. The user 105 then progresses to GUI 1500 shown in FIG. 15.

The user 105 is able to select from the (technical) library of ‘filter’ methods available on GUI 1500 of FIG. 15. This selection then determines the methodology workflow to allow the user 105 to calibrate their chosen filter(s). The filter(s) may be selected and/or applied in any order and be of any number. The filter(s) may be applied in different ways to entry and exit signals and per the naming convention used for the signals generated (GUI 1500).

Hence, the filter(s) may be applied in different ways to the entire portfolio and/or specific parts of the portfolio/process in FIG. 2 such as: UserName (Xxxx); Portfolio & associated benchmark setting (P1B1); Signal Generation Type (BO—for Break Outs); Direction (BTO or STO); Signal setting(s) (55 for BTO & 30 for STO respectively); Instrument (Unique identifier for each portfolio instrument e.g. yyyyy). For example, in one embodiment where the system administrator wishes to guide the user 105 to set different filter settings for long and short positions then two separate filter symbols may be shown to enable the user 105 to accomplish this specific action. In this embodiment the user 105 is only able to use a single filter method on GUI 1500 for both long and short positions.

What is shown on GUI 1500 are the potential settings for a default price filter (shown in 1505) and the subsequent choice of ‘lowest relative price change’ filter shown in 1510.

The default price filter works by taking the value selected by the user 105 (0.5/1.0/1.5/2.0/2.5 . . . 5.0) in increments of 0.5 & then multiplying the value by the current ATR value for that underlying instrument being assessed. This becomes a filter value to add (for long positions) to any calculated ‘entry signal price’ to generate the ‘entry signal filter price’. In this embodiment if the 30-day ATR for instrument yyyy=5 & the filter is set to 2 and the signal was generated when the closing price for that trading day=100, then the ‘entry signal filter price’=110.

The second filter in this embodiment (lowest relative price change 1510) takes the ‘n’ value selected by the user 105 and calculates the price change based on closing prices (today's closing price/closing price ‘n’ [25] days ago)*100%. This filter is only applied when there is more than 1 entry signal generated at the same time and both are potentially valid for selection in the portfolio given current exposures. These results are ranked for all instruments in the portfolio and the lowest ranked price changes first (with calculations down to, 8DP of accuracy). Where that is tied then the alphanumeric unique identifier for the instrument is used as the final selection filter.

This filtering phase may be set to occur after the portfolio management rules have been appraised and hence, maintain a specific logical sequence given the workflow being shown in this embodiment.

Hence, the first ranked signal may actually be long. However, the process in FIG. 2 may be set to balance long and short positions continuously. Hence, if the current portfolio is ‘net long’ then the process in FIG. 2 will look for the next (highest ranked) short position which is this case may be in, second place in the ‘lowest relative price change’ rankings.

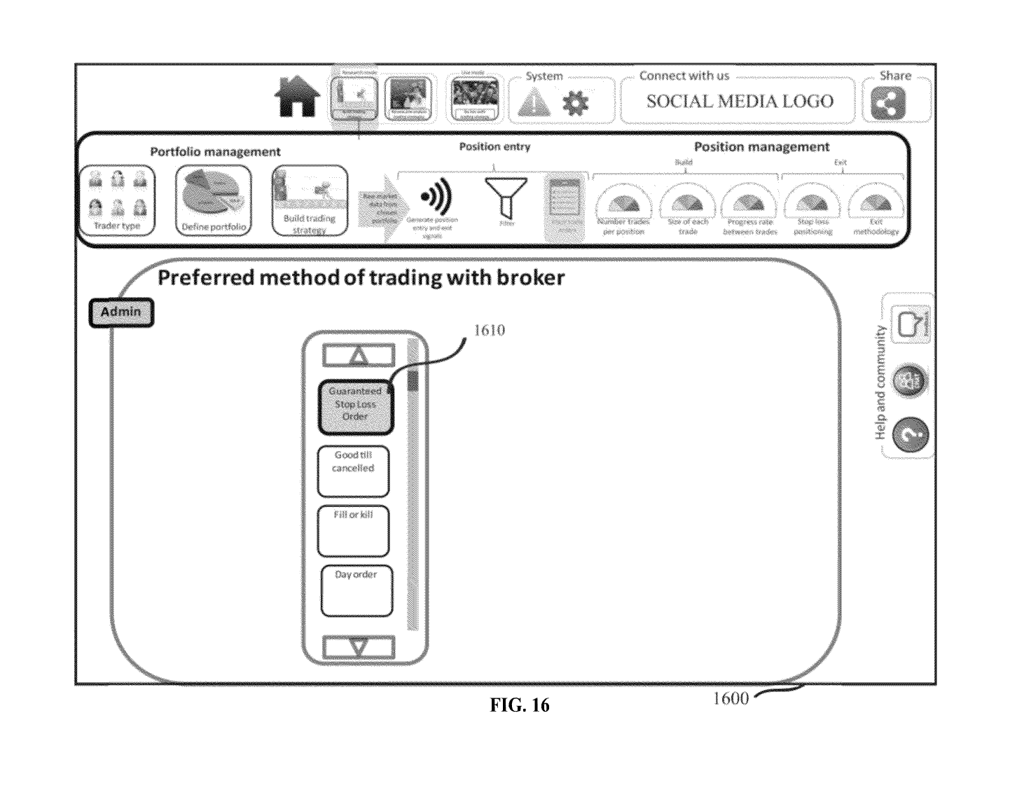

Selection and calibration of trading filters is thus complete as in step 240 of FIG. 2. Once the selection has been made the user 105 progresses to GUI 1600, FIG. 16.

The user 105 is able to select from the library of ‘order’ methods available as shown on the GUI 1600 of FIG. 16. This selection then determines the methodology workflow to allow the user 105 to calibrate their chosen order type.

The orders may be selected and/or applied in any order and be of any number. The orders may be applied in different ways to entry and exit signals and any naming conventions used and hence the orders may be applied in different ways to the entire portfolio and/or specific parts of the portfolio.

This embodiment shows the selection of the ‘Guaranteed stop loss’ order 1610 (based on the ‘spread betting’ mode chosen—this type of order is unique to this method of participating in the markets).

For structured order types the chosen method will also account for any structured/options position.

Step “select order method” is completed and the user 105 progresses to GUI 1700 shown in FIG. 17.

The user 105 is able to select from the list of numbers of trades available on GUI 1700. This selection then determines the methodology workflow to allow the user 105 to calibrate their preferred way of building and managing a position/trading pyramid. The selection may take any form such as selecting a field within the table and/or interacting with a vertical slider.

The trades may be of any number e.g. 8 trades are shown selected by slider 1710 and as set by the portfolio limits table 1020, FIG. 10B. The trades may be applied in different ways according to entry signal type(s) and/or any other aspects of the process in FIG. 2 e.g. the user 105 may decide to trade positions up to 8 trades for long positions but only up to 6 trades for short positions. What is shown in GUI 1700 in this embodiment is a single setting for both long and short positions. In this embodiment chooses 8 trades per position.

Once the selection has been made as in step 250 of FIG. 2, the user 105 progresses to GUI 1800, FIG. 18.

On GUI 1800 the user 105 is able to select the ‘size of each’ trade based on those made available. The size of each trade may be set in any way using the scale e.g. the trades may be of the same size or of different sizes. The scales used throughout the process in FIG. 2 may be of any type/combination(s) such as percentages; sizing chart symbols; words; numeric scales; colour sequences; etc. The selection may take any form such as selecting a field within the table and/or interacting with a horizontal slider and/or selecting one of the column headers/any part(s) of the scale shown. The scale shown may map to a % scale such as 0.5%-10% in increments of 0.5% (for trade count 1-10) and 0.5%-5% in increments of 0.5% (for trade count 11-20). The percentages are expressed as a % of starting capital (for our single portfolio) e.g. % selected*£1,000=size of a trade. Assume 1% is selected for each trade (small). The trade sizes may be applied in different ways to any aspects of the process in FIG. 2 such as the trade sizes may be applied in different ways for ‘long’ (smaller sizes at 0.5%) and ‘short’ positions (larger sizes at 1.0%) & where the user 105 is subsequently presented with 2 tables (one for long position settings and the other for short position settings). In this embodiment one table 1810 is shown for all position types.

Once the size of each trade within position is selected, step 255 of flow chart shown in FIG. 2 is completed and the user 105 progresses to GUI 1900.

The user 105 is able to select the ‘progress rate’ on GUI 1900 as in FIG. 19 from one trade to the next trade based on those made available. The ‘progress rate’ from one trade to the next trade may be set in any way using the scale e.g. the progress rates may be of the same size or of different sizes. The scale may be of any type such as percentages; ATR; volume based; etc. The selection may take any form such as selecting a field within the table and/or interacting with a horizontal slider and/or selecting one of the column headers/any part(s) of the scale shown. The user 105 chooses ‘ATR’ and a setting of 1-ATR for all trades, where ATR=5. So for every 5p rise (for long positions) in the price of the instrument the process in FIG. 2 will generate an additional buy order and progress to the next unit in the table.

The progress rates may be applied in different ways to any aspects of the process in FIG. 2 such as the progress rates may be applied in different ways for ‘long’ (quicker rate at 0.5 ATR) and ‘short’ positions (slower rate at 1.0 ATR) & where the user 105 is subsequently presented with two tables (one for long position settings and the other for short position settings). In this embodiment one table 1910 is shown for all position types.

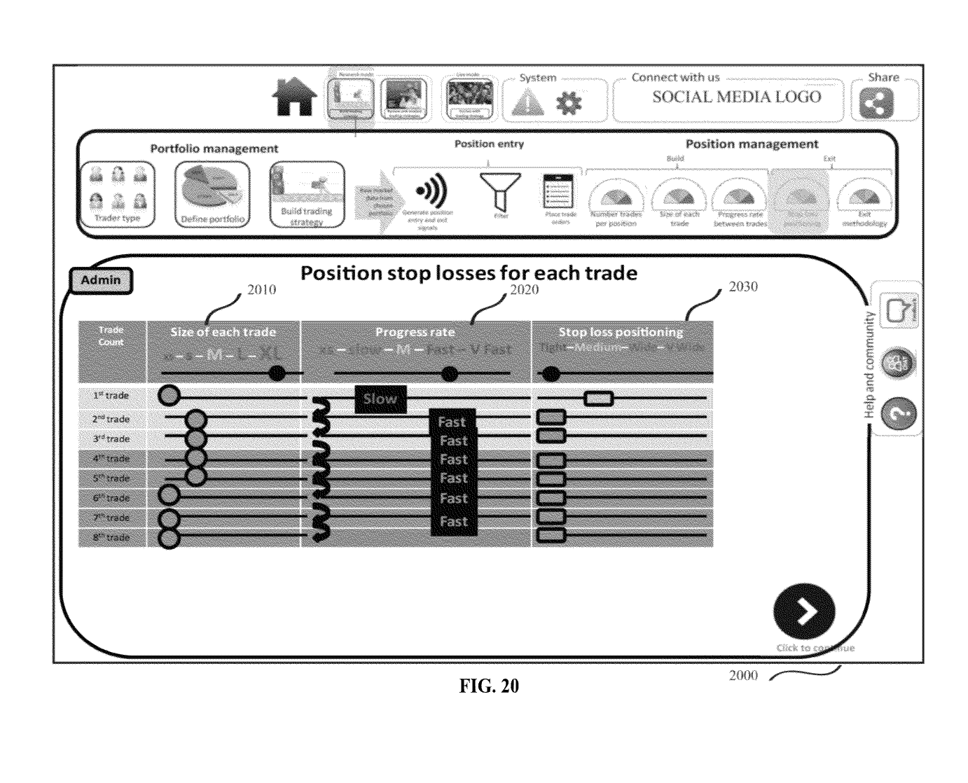

Thus step 260 of flow chart shown in FIG. 2 is completed and the user 105 progresses to GUI 2000 of FIG. 20.

The user 105 is able to select the ‘stop loss position’ for any trade and based on those made available. The ‘stop loss position’ may be set in any way using the scale e.g. the stop loss position may be different for any/all trades. The scale may be of any type such as percentages; ATR; currency amount; etc. The selection may take any form such as selecting a field within the table and/or interacting with a horizontal slider and/or selecting one of the column headers/any part(s) of the scale 2010 shown in FIG. 20. It is assumed in this example that the user 105 chooses an ATR scale and hence, selects 2-ATR as the stop loss position for trade (Unit) 1 and 1-ATR for all other trades (Units).

In one embodiment of the present disclosure, the stop loss position may be applied in different ways to specific entry signals. The stop loss position rates may be applied in different ways to the entire portfolio and/or specific parts of the portfolio. The stop loss position may be applied in different ways for ‘long’ and ‘short’ positions. The stop loss position may be applied in different ways for ‘current exposure’.

FIG. 22A shows a Position Manager table where the starting equity is £1,000 & ATR at the time the signal was generated for instrument yyyy is 5. For short positions the progress rate result is multiplied by −1. Column 2210 shows size of each trade corresponding to interactive graphic display 2010 on GUI 2000 of FIG. 20. Accordingly, column 2220 and 2230 of the table from FIG. 22A indicates the progress rate and stop loss positioning set by the user 105 through graphic display 2020 and 2030 on GUI 2000 shown in FIG. 20.

The following values are shown in the table of FIG. 22B: Trigger price from signal generator=100, Entry filter set=2, ATR=5, Unit 1 entry price=100+(2*5)=110.

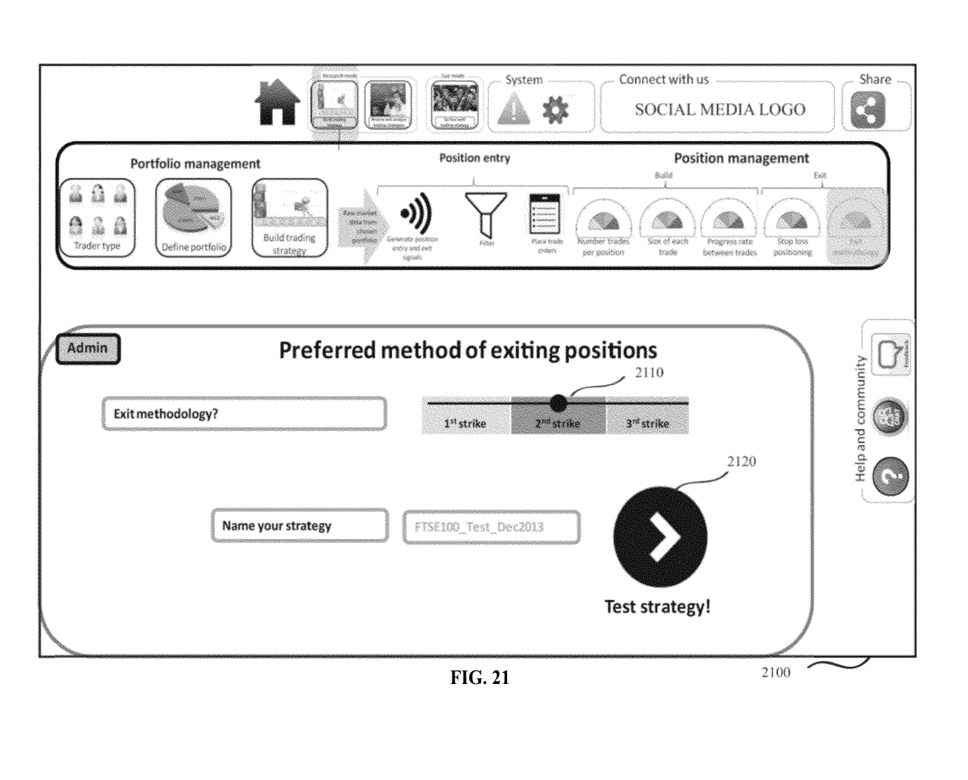

Once the position stop losses for each trade is selected as in step 265 of flow chart for the present disclosure as shown in FIG. 2, the user 105 progresses to GUI 2100 shown in FIG. 21.

On GUI 2100, FIG. 21, the user 105 is able to select the ‘exit methodology’ for any position and based on those made available. The ‘exit methodology’ may be set in any way using the scale e.g. the stop loss position may be different for any/all positions. The scale may be of any type such as strikes; signal types; etc. The selection may take any form such as selecting a field within the table and/or interacting with a horizontal slider and/any part(s) of the scale shown. In this embodiment the user 105 has chosen ‘2^{nd} strike’ by positioning the slider at 2110.

The exit methodology may be applied in different ways to any aspects of the process in FIG. 2 such as for ‘short’ positions the ‘1^{st} strike’ method may be used whereas for ‘long’ positions the ‘2^{nd} strike’ may be used & where the user 105 is subsequently presented with 2 tables (one for long position settings and the other for short position settings).

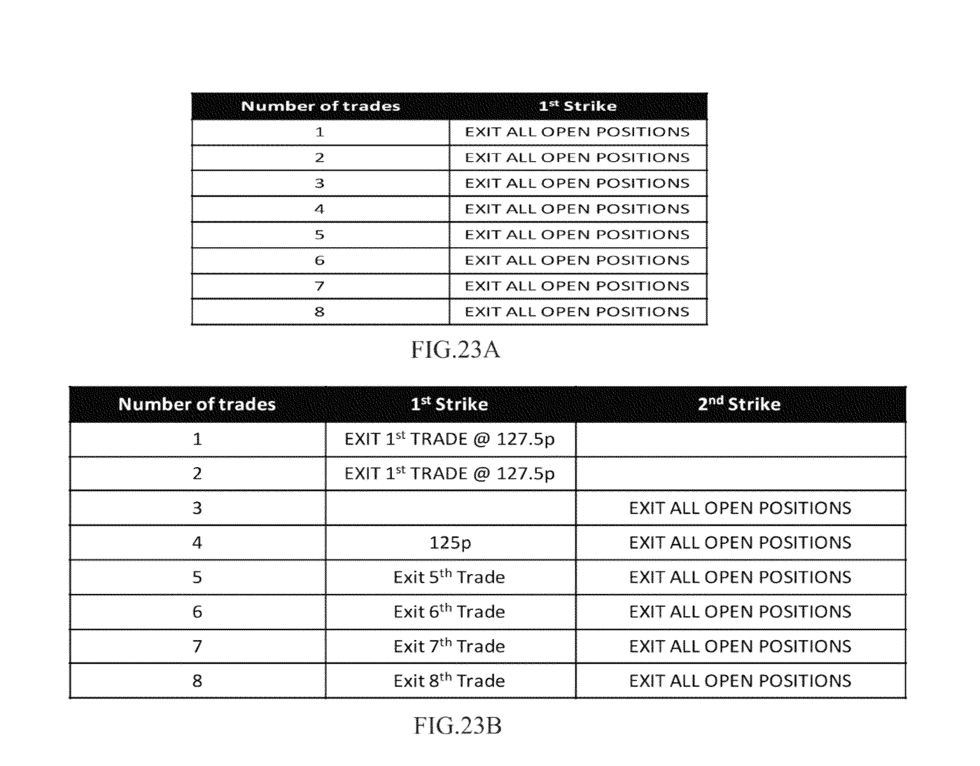

FIG. 23A shows an Exit Manager Table for a First Strike method. As soon as an exit signal is triggered (‘stop loss’ triggered, closing signal generated, etc) then the systems exits all open trades for that specific position and at the trigger price. For example, at trade count=3 the stop loss=115p. When, the price of yyyy on trading day ‘n’=115p then the process in FIG. 2 closes out all open trades such as 1, 2 and 3.

FIG. 23B shows an Exit Manager Table for a Second Strike method. It is more structured in two steps-as soon as the first exit signal is triggered (stop loss for trade 8 @127.5p) then exit, the first two trades for that specific position and retreat back into the position manager table based upon the market price. If the market price falls to, 125p then ‘retreat back to trade 4 (per the progress rate column). If the size of the price drop takes the user 105 to a position that overlaps with the first strike settings then this is in effect an absolute exit and the position is closed entirely e.g. the price drops to 120p. If any trades are left open then the process in FIG. 2 of the present disclosure carries on trading. When a second exit signal is generated then exit all remaining open trades for that position. For example, if after ‘n’ days user 105 continues trading from trade 4 back up to trade 8 and the price again breaches the trade 8 stop loss then this triggers an exit of all current open trades for that position and regardless of how big the price drop e.g. exit positions 8-3 inclusive.

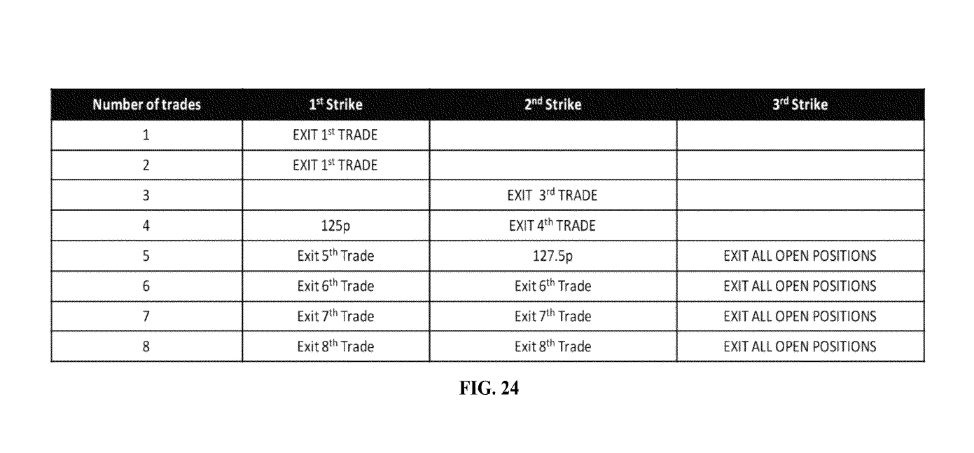

Using the same example for two strikes, an Exit Manager Table for Third Strike is shown in FIG. 24. The Third Strike method is even more structured. It consists of three steps—as soon as an exit signal is triggered (stop loss being one of several) at trade 8, then exit, the first 2 trades for that specific position & retreat back into the position manager table based upon the market price. If the market price takes user 105 back into the table to trade 2 then exit the entire position, else carry on trading.

As soon as a second exit signal is triggered (stop loss being one of several) at trade 8 then exit only, trades 3 and 4 for that specific position and retreat back into the position manager table based upon the market price. If the market price takes the user 105 back into the table to trade 4 then exit the entire position, else carry on trading. When a third exit signal is generated then exit all remaining open positions for that position regardless of the price change.

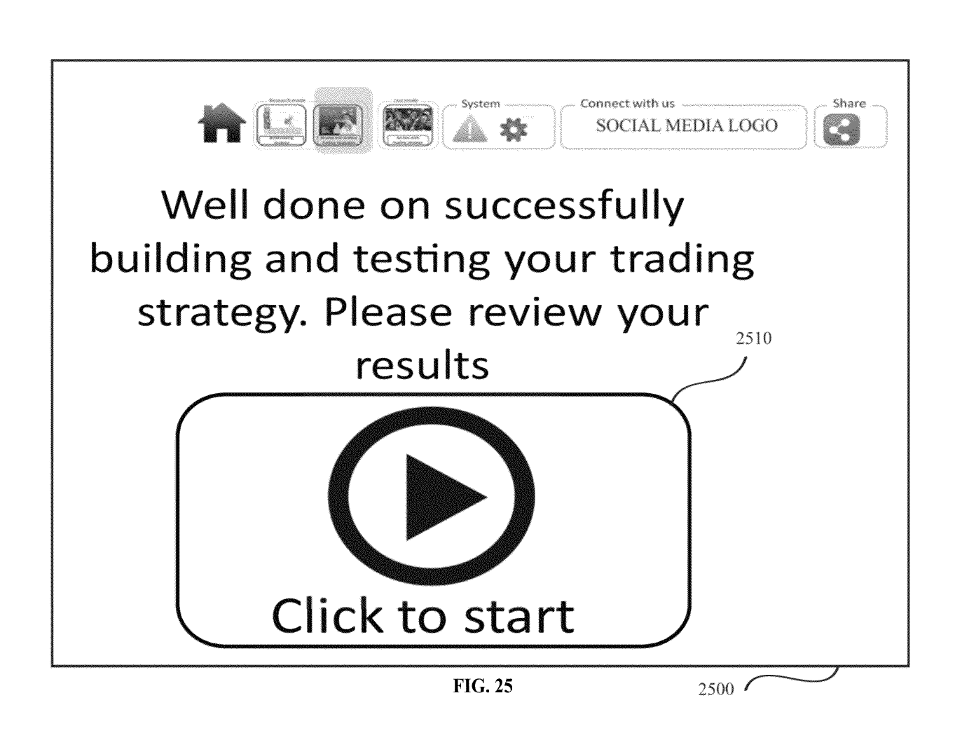

At this stage, after step 270 shown in flow chart of FIG. 2, building of a trading strategy by the user 105 is complete and the trading strategy may now be tested by clicking on the symbol 2120 on GUI 2100 shown in FIG. 21. After testing as in step 275, FIG. 2, moving on to GUI 2500 shown in FIG. 25, the trading strategy result may be reviewed by the user 105 by clicking on the symbol 2510. Reviewing is done in step 280 of flow chart shown in FIG. 2. The trading strategy built by the user 105 is ready for implementation as in step 285 of flow chart in FIG. 2.

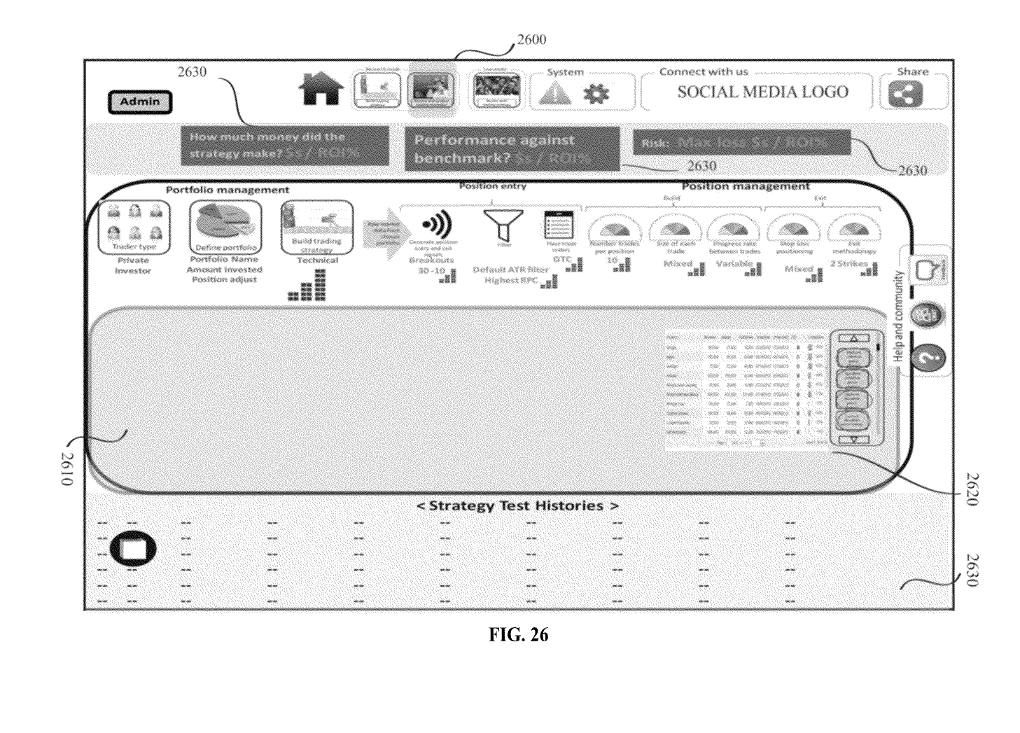

In a preferred embodiment of the present disclosure, the user 105 is able to select any number or combination of Key Performance Indicators (KPIs) for presentation and based on those made available. Custom KPIs are also available for creation and selection including those created by other user 105. Shown as symbol 2630 on GUI 2600 in FIG. 26, in this exemplary embodiment of the present disclosure the user 105 has chosen three KPIs based on those available.

In another preferred embodiment of the present disclosure, the user 105 may review, edit or change set in any way their chosen strategy within the ‘review strategy’ section of the screen in space 2610. The process in FIG. 2 of the present disclosure takes the user 105 through GUIs 600-2100 (FIG. 6 to FIG. 21) and allows to make any changes necessary. The user 105 is able to make changes and that were available originally. And at any point the user 105 may commit those changes for re-testing. The results of which may be shown in the KPI section(s). Hence, the user 105 may decide to change a single option, parts of the process in FIG. 2 and/or the entire process in FIG. 2 and commit to re-test those changes at any time. The results may also be viewable in the area 2620 allocated for showing specific graphs/charts/other visual artifacts pertinent to that specific part of the strategy and/or any selected KPIs chosen by the user 105.

In a preferred embodiment, for each step shown in GUIs 600 to 2100, the user 105 may also select relevant additional information such as KPIs and/or charts/graphs to be displayed to show the results of their settings for the strategy as a whole and/or for that specific part of the strategy. The KPIs may be bespoke or from a pre-defined library. The charts may be bespoken or from a pre-defined library. The user 105 may navigate forwards and backwards.

The user 105 is able to review, filter, sort and/or otherwise interact with the results of any/all prior tests such as in the form of a results history table that shows up at space 2630 on GUI 2600, FIG. 26. The headings of the table may align to key systems settings/components such as ‘trader type’; ‘portfolio name’; ‘risk profile’; etc. The user 105 is able to make changes to their portfolio in this view and/or by selecting the strategy to become their chosen strategy for detailed review in this screen.

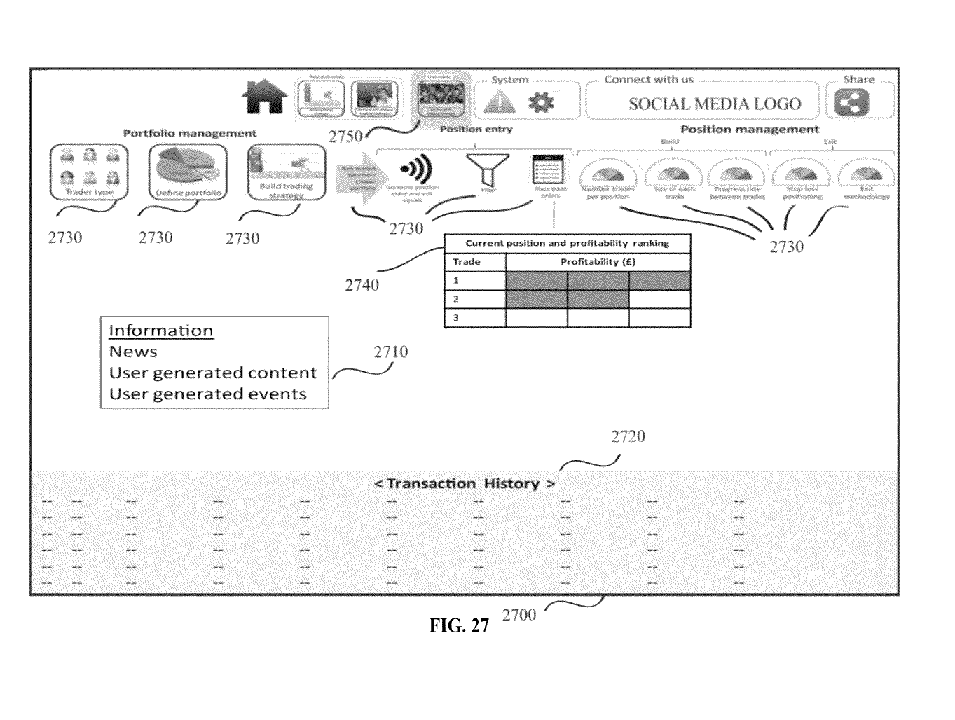

GUI 2700, FIG. 27, shows the GUI 2700 of the present disclosure in live implementation mode as indicated by highlighted symbol 2750, i.e. implementing the trading strategy. The user 105 is able to select any number or combination of ‘KPIs’ (KPIs are represented by symbols 2730 on GUI 2700) for presentation and based on those made available. Custom KPIs are also available for creation and selection. One configuration of KPIs is to align current trade entry/exit signals within the overall context of the position and align the position back to the overall portfolio performance and the most profitable positions to date as shown in table 2740 on GUI 2700. Thus the GUI 2700 enables the user 105 to calibrate all aspects of the trading strategy including the signal generator (FIG. 14), the order type (FIG. 16) and the position management (FIGS. 17-20).

The space 2710 on the part of the GUI 2700 allows user 105 to execute orders. These may be aligned to position objects that provide context on specific trades within the overall position such as trade count, relative size, etc. In addition this may include other information such as news, user 105 generated content/data, any graphs/charts/analysis; links to 3^{rd} party brokers/trade execution services; etc. The workflow may be colour coded such red for high priority trades, etc. The user 105 may have access to other information such as user 105 generated content and/or user 105 generated events etc.

The user 105 is able to review, filter, sort and/or otherwise interact with the history of any/all prior trades such as in the form of a transactions history table 2720 on GUI 2700. The headings of the table may align to key systems settings/components such as ‘trade type’; ‘portfolio name’; ‘trade count’; etc. The user 105 is able to make changes to their view and/or by selecting the transaction to become their chosen transaction within the screen.

In a preferred embodiment of the present disclosure, any user 105 may generate any type of content and make that available for publishing and/or sharing with other users/user groups. For example, a user 105 may wish to share a forecast on any event such as the price of a specific instrument, or an actual economic event.

Any user 105 may wish to create and/or share an event which may be based on an actual event (current or future) such as an earnings report for a specific company. The user 105 may wish to structure the event in any way and make it available to any other users/user groups. The event may be structured in any way to allow other user 105 to respond. For example: Event title: What is the likely future impact of the unemployment figures for country x on the share price of instrument yyyy? The user 105 has 1-day [specific time period] to reply to this event.

Available responses: The price of instrument yyyy may rise/fall/trade within range [available options] of x/y/x-y % respectively over the next ‘n’ trading days [available options may be set by the user 105 at 5-50 trading days].

User 105 may generate any types of events such as discrete and/or multiple inter-related events. A user 105 that generates events may be assessed based on feedback from other users; number of responses to the event; etc.

User 105 participating in the event may be assessed in various ways such as (a) accuracy of their responses at the end of the time limit set for the event; (b) timeliness of their original reply; etc. Weightings for events may differ between events. Measures may be both qualitative (user feedback forms) and quantitative (number of actual respondents).

The following are examples of what a user 105 such as a system administrator may do to change any/all systems settings and directly/indirectly impact the user 105 experience in the GUI 300 of the present disclosure:

### i. Abstraction

Entire system in FIG. 1 and process in FIG. 2 adopts a services orientated architecture whereby any part of the system in FIG. 1 and process in FIG. 2 may be abstracted from all other parts of the system in FIG. 1/process in FIG. 2. Hence, any system(s) component may be created, adapted and/or otherwise customised in any way to achieve any outcome. This may be done in any way such as via a parameter tables.

### ii. Mode(s)

Define and create any mode(s) and associated structure(s)/attribute(s)/hierarchies

### iii. Trader Profile(s)

Define and create any user 105/trader profile(s) and associated structure(s)/attribute(s)/hierarchies

Hence, the same profile name may have different attribute(s) in different embodiments, etc

### iv. Statistics/Mathematics

Use any type of statistical/mathematical/logical/programmatic capability with any part(s) of the process in FIG. 2 such as portfolio correlation studies

### v. Portfolio(s)

Define and create any portfolio(s) and associated structure(s)/attribute(s)/hierarchies/sub-categories e.g. FX, equity, commodity, high risk, low risk, etc

### vi. Management Method(s)

Define and create any method(s) and associated structure(s)/attribute(s)/hierarchies/sub-categories to apply to any part(s) of the process in FIG. 2 e.g. any management method(s) may be applied to any part(s) of portfolio(s)

### vii. Impact/Relationships/Inter-Relationships

Any part of the process in FIG. 2 may impact any other part(s) of the process in FIG. 2 for example trade selection may impact portfolio correlation which may subsequently impact portfolio limit settings

### viii. Trading Style(s)

Define and create any trading style(s) and associated structure(s)/attribute(s)/hierarchies

### ix. Trading Method(s)

Define and create any trading method(s) and associated structure(s)/attribute(s)/hierarchies for developing any combinations(s) of entry and exit signals

### x. Filter(s)

Define and create any filter(s) and associated structure(s)/attribute(s)/hierarchies for developing any combinations(s) of filter(s) &/or for turning filters on/off under any/all conditions & based on any value(s) such as price, volume(s), fundamentals data, calendar event(s), combinations of value(s), etc and executed in any sequence

### xi. Order(s)

Define and create any order(s) and associated structure(s)/attribute(s)/hierarchies for generating order(s) that may be associated with any other part(s) of the process in FIG. 2 such as broker type e.g. orders direct to a floor trader may differ for those sent to and spread across a group of screen based brokers

### xii. Nos Trade(s)

Define and create any number of trade(s) that may be associated with any other part(s) of the process in FIG. 2 such as generate an ‘x’ trade management plan for a short signal and a ‘y’ trade management plan for a long signal. Other exemplars may include: instrument type; portfolio; current exposure; correlation; etc, etc

### xiii. Size of Trade(s)

Define and create any combination/sequence/structure of trade size(s) that may be associated with any other part(s) of the process in FIG. 2 such as generate trade(s) of size ‘x’ for a short signal and generate trade(s) of size ‘y’ for a long signal. Size may be determined/defined by any parameter e.g. price, risk, volume, etc

### xiv. Progress Rate(s)

Define and create any combination/sequence/structure of progress rate(s) that may be associated with any other part(s) of the process in FIG. 2 such as generate progress rate(s) of size ‘x’ for a short signal and generate progress rate(s) of size ‘y’ for a long signal. Size may be determined/defined by any parameter e.g. price, risk, volume, etc

### xv. Stop Loss(es)

Define and create any combination/sequence/structure of stop loss(es) that may be associated with any other part(s) of the process in FIG. 2 such as generate stop loss(es) of size ‘x’ for a short signal and generate stop loss(es) of size ‘y’ for a long signal. Size may be determined/defined by any parameter e.g. price, risk, volume, etc

### xvi. Exit Method(s)

Define and create any combination/sequence/structure of steps for exiting any/all part(s) of a position and that may be associated with any other part(s) of the process in FIG. 2 such as generate an ‘a’ step exit plan of size ‘x’ for a short signal and generate a ‘b’ step exit plan of size ‘y’ for a long signal. Size may be determined/defined by any parameter(s) e.g. price, risk, volume, etc. Steps may be structured in any way and determined defined by any parameter(s) e.g. price, risk, volume, etc.

### xvii. Result(s)

Define and create any combination/sequence/structure of steps for assisting the user 105 in viewing, reviewing, changing, re-testing and analysing their results and which may be structured or otherwise presented in any way

### xviii. Implementation

Define and create any combination/sequence/structure of steps for assisting the user 105 in implementing, monitoring, reviewing, changing, re-testing and analysing their strategy and which may be structured or otherwise presented in any way

### xix. Programming and Customisation

A language framework that allows the user 105/any 3rd party to define, create, extend, integrate or otherwise modify/adapt any parts of the process in FIG. 2 in any combination/sequence/structure of steps for assisting the user 105/any 3rd party in implementing, monitoring, reviewing, changing, re-testing and analysing any parts of the process in FIG. 2, such as their strategy and which may be structured or otherwise presented in any way. This may include setting alerts when the price of any instrument(s) reaches a certain level. Another embodiment may include tagging and sharing any type of data across the process in FIG. 2 and/or any other system(s)/user 105. Another embodiment may allow the user 105 to customise the functionality of any part of the process in FIG. 2 to meet their requirements such as using a volume based filter for a specific portfolio. Another embodiment may include analysis of 3rd party systems (such as social media information) to provide a level of analysis based on, user 105 selected key words and associated workflows and to support decision making such as, which signal to take and how to adjust trading size based on this analysis.

Hence, potentially every single instrument within a portfolio may have its own entirely customised trading strategy being traded and managed in parallel and within a larger portfolio of instruments and/or across different portfolio(s).

In a preferred embodiment of the present disclosure, the macro settings in the GUI 300 can be changed, such as language; screen layout; colour schemes; symbols being used; sequence and direction of screen workflow; scales used; wording; images used; etc.

It should be understood by one of skilled in the art that some of the functions described as being performed by a specific component of the process in FIG. 2 may be performed by a different component of the system in FIG. 1 in other embodiments of this disclosure.

The present disclosure can be practiced by employing conventional tools, methodology and components. Accordingly, the details of such tools, component and methodology are not set forth herein in detail. In the previous descriptions, numerous specific details are set forth, in order to provide a thorough understanding of the present disclosure.

However, it should be recognized that the present disclosure might be practiced without resorting to the details specifically set forth.

In the description and claims of embodiments of the present disclosure, each of the words, “comprise” “include” and “have”, and forms thereof, are not necessarily limited to members in a list with which the words may be associated.

Only exemplary embodiments of the present disclosure and but a few examples of its versatility are shown and described in the present disclosure. It is to be understood that the present disclosure is capable of use in various other combinations and environments such as accounting; customer relationship management; reporting; analysis; process creation and management; resource management; workflow management; supply chain management; government services; public safety; security; etc and is capable of changes or modifications within the scope of the inventive concept as expressed herein.

In the preceding description, numerous specific details are set forth in order to provide a thorough understanding of the disclosure. However, it will be understood by those skilled in the art that the present disclosure may be practiced without these specific details. In other instances, well-known methods, procedures and components have not been described in detail so as not to obscure the present disclosure.

Unless specifically stated otherwise, as apparent from the preceding discussions, it is appreciated that throughout the specification discussions utilizing terms such as “selecting”, “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers or any type of 3rd party server/3rd party infrastructure/3rd party services e.g. Google Cloud Services; Microsoft Azure; AWS; Private Cloud infrastructure; etc and in any form, e.g., physical, virtual, etc.

Embodiments of the present disclosure may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosures as described herein.

It should be understood that any topology, technology, and/or standard for computer networking (e.g., mesh networks, infiniband connections, Remote Directory Memory Access, etc.), known today or to be devised in the future, may be applicable to the present disclosure.

1. A method for developing trading strategies through a graphical user interface, comprising:
receiving a selection of a strategy mode through the graphical user interface;
receiving a selection of a trader profile through the graphical user interface;
creating a portfolio for said received selection of the trader profile based on said received selection of the strategy mode;
receiving a selection of a trading style through the graphical user interface;
generating a trading style;
receiving a selection of signal filters through the graphical user interface;
receiving a selection of order methods through the graphical user interface;
receiving a selection of a number of trades through said graphical user interface;
receiving a selection of a size of each of the selected trades within position through the graphical user interface;
receiving a selection of a rate to add to each of the selected trades through the graphical user interface;
positioning stop losses for each of the selected trades through the graphical user interface;
receiving a selection of a preferred mode of an exiting position through the graphical user interface;
testing a trading strategy for each of the selected trades based on said received selection of order methods, number of trades, and positioned stop losses;
implementing said tested trading strategy;
wherein said graphical user interface uses symbols and context to facilitate a user to perform at least one of said testing and implementing of the trading strategy.

2. The method of claim 1, wherein said receiving the selection of the mode includes at least one of receiving a spread betting mode, an education mode, and a strategy mode.

3. The method of claim 1, wherein said user interface is provided on a client device.

4. The method of claim 3, wherein said client device includes at least one of a desktop computer, laptop computer, smart phone, and tablet.

5. The method of claim 1, wherein said receiving a selection of signal filters includes receiving a default price filter, and said process further includes disabling a secondary filter based on said default price filter.

6. The method of claim 1, further comprising creating a table for each of said created portfolios.

7. The method of claim 6, further comprising conducting correlation tests based on the created tables.
